(19) United States
(12) Patent Application Publication
(10) Pub. No.: US 2007/0276768 A1
(43) Pub. Date: Nov. 29, 2007

(54) Trusted third party services system and method

(76) Inventor: Joseph T. Pallante, Philadelphia, PA (US)

Correspondence Address: Todd A. Norton;REED SMITH LLP, 2500 One Liberty Place, 1650 Market Street, Philadelphia, PA, 19103-7301, US

(21) Appl. No.: 11/509,795

(22) Filed: Aug. 24, 2006

Related U.S. Application Data
(63) Continuation of application No. 10/037,263, filed on Dec. 31, 2001, now abandoned.
(60) Provisional application No. 60/310,326, filed on Aug. 6, 2001.

(51) Int. Cl. G06F 19/00

(52) U.S. Cl. 705/78

(57) ABSTRACT

A method for providing transactional billing for trusted third party services offered to a plurality of users via a computer network, the method including: generating at least one log record indicative of at least one of the users submitting at least one electronic document for trusted third party services; generating at least one log record indicative of forwarding the at least one electronic document to at least a second of the plurality of users; parsing the log records to generate billing information associated; and, providing the billing information to at least one processing application. The processing application processes the billing information and generates a plurality of bills dependently thereupon.

This application claims priority of U.S. Patent Application Ser. No. 60/310,326, filed Aug. 6, 2001, entitled “TRUSTED THIRD PARTY SERVICES SYSTEM AND METHOD”.

### FIELD OF INVENTION

The present invention relates generally to trusted third party services, and more particularly to providing trusted third party services.

### BACKGROUND OF INVENTION

Generally, a Trusted Third Party (“TTP”) is an impartial organization that delivers business confidence, through commercial and technical security features, to an electronic transaction. It supplies technically and legally reliable means for carrying out, facilitating, producing independent evidence about and/or arbitrating on an electronic transaction, for example.

There is a need for TTP services suitable for conveying electronic documents between a plurality of users via a computer network.

### SUMMARY OF INVENTION

A method for providing transactional billing for trusted third party services offered to a plurality of users via a computer network, the method including: generating at least one log record indicative of at least one of the users submitting at least one electronic document for trusted third party services; generating at least one log record indicative of forwarding the at least one electronic document to at least a second of the plurality of users; parsing the log records to generate billing information associated; and, providing the billing information to at least one processing application which processes the billing information and generates a plurality of bills dependently thereupon.

### BRIEF DESCRIPTION OF THE DRAWINGS

The invention will be better understood with reference to the following illustrative and non-limiting drawings, wherein like references identify like elements of the invention there-throughout, and:

FIG. 1 illustrates an overview of Trusted Third Party (“TTP”) document transmission and security services according to one exemplary embodiment of the present invention;

FIG. 2 illustrates a TTP system overview according to one exemplary embodiment of the present invention;

FIG. 3 illustrates a Certificate Management System (“CMS”) overview according to one exemplary embodiment of the present invention;

FIG. 4 illustrates document server components according to one exemplary embodiment of the present invention;

FIG. 5 illustrates a user hierarchy according to one exemplary embodiment of the present invention;

FIG. 6 illustrates a document hierarchy according to one exemplary embodiment of the present invention;

FIG. 7 illustrates paths to an uploaded document according to one exemplary embodiment of the present invention;

FIG. 8 illustrates access control links according to one exemplary embodiment of the present invention.

FIG. 9 illustrates Access Control Links (“ACLs”) relating to an uploaded document according to one exemplary embodiment of the present invention;

FIG. 10 illustrates time services according to one exemplary embodiment of the present invention;

FIG. 11 illustrates billing services according to one exemplary embodiment of the present invention;

FIG. 12 illustrates document transmission—user authentication according to one exemplary embodiment of the present invention;

FIG. 13 illustrates document transmission—upload processing according to one exemplary embodiment of the present invention; and,

FIG. 14 illustrates document transmission—delivery processing according to one exemplary embodiment of the present invention.

### DETAILED DESCRIPTION OF THE PREFERRED EMBODIMENT

The present invention relates to requirements for and proposes an architecture for a computer system that provides Trusted Third Party (“TTP”) services to licensed professionals for secure handling of documents.

According to an embodiment of the present invention, a system operator (“SYSOP”) operates the TTP system. Licensed professionals and other individuals use the system as an intermediary for sending and receiving documents; these parties can access the system via the interconnection of computers and computer networks commonly referred to as the Internet using a world-wide-web (“www”) browser or electronic-mail client applications.

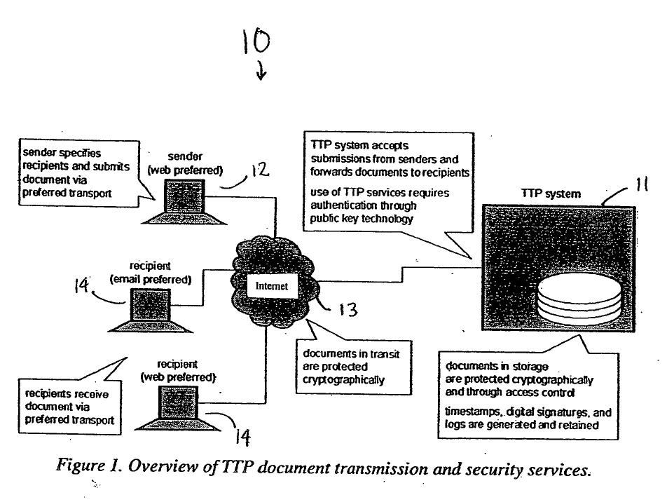

Referring now to FIG. 1, there is shown an overview 10 of TTP document transmission and security services according to one embodiment of the present invention. Generally, the overview 10 includes a TTP system 11, users 12, 14 and network 13. The predominant function of the TTP system 11 is to transmit or convey electronic documents between users (senders 12 and recipients 14). A user, sender 12 for example, submits a document to the system 11, specifying one or more other users, recipients 14 for example. The system 11 propagates the document to the recipients 14 via a web-based or e-mail-based transport, preferred by each recipient 14 for example, across network 13. Other functions of the TTP system 11 preferably include tracking and storage of documents. The overview 10 according to the present invention offers a range of security assurances, including: authentication of the sending and receiving parties; protection of documents in transit and in storage, through data encryption and access control; and proof of sending and receipt, through timestamping, digital singing, and logging.

The TTP services provided by the SYSOP deliver a novel combination of features and benefits to professionals and their clients, enabling convenient, efficient, reliable, and secure sharing of information. While the description of the present invention is according to a comprehensive TTP system, it is expected that some offering of a TTP system according to the present invention will implement a subset of this. Implementations may also depart in some respects from the architecture.

For sake of clarity, the parties who will be involved in providing and consuming TTP services and the documents that will be handled by the TTP system will be described in a non-limiting manner. These parties generally include a SYSOP's TTP staff which serves as the operators of the TTP system, providing TTP services to the users of the system. Users may be aggregated into groups. SYSOP's TTP customers preferably contract with a SYSOP as subscribers to TTP services and enroll individuals as users. These subscribing entities may be firms of licensed professionals, other types of organizations, or individuals, for example. For convenience, subscribing entities will also be referred to herein as firms, but a subscribing entity may be any organization or individual that subscribes to TTP services. Further, while the present invention will be described in a non-limiting manner herein as it relates to law firms, and law firm clients, for sake of explanation only, it should be understood that the present invention has broad applicability to many industries though.

SYSOPs may enter into agreements with individuals or organizations who assume a share of responsibility for authenticating the identities of users or potential users. For example, a professional association may authenticate its members, and a firm may authenticate its clients. These authenticating entities authorize the registration of users with SYSOP, possibly having performed functions such as verification of names and addresses and background checking.

As will be evident to one possessing an ordinary skill in the pertinent art, a SYSOP is the trusted third party to the users. SYSOP staff will serve as operators of the TTP system. Each member of the operational staff is preferably conferred a distinct security identity within the TTP system. These individuals are preferably authorized only to perform operational tasks.

As set forth, firms preferably contract with SYSOP for TTP services and enroll individuals as users of the TTP system. The relationship between a user and a firm may take various forms; for example, a user may be an employee of the firm, a consultant to the firm, or a client of the firm. Users interact with the TTP system to send, receive, store, retrieve, or perform other operations on documents.

Each user is preferably conferred a distinct security identity within the TTP system. Each firm is defined as a group, whose members will include all of the users enrolled by the firm. The grouping of users into firms facilitates the management of services such as user enrollment, access control, and billing. Groups can also be defined for subsets of the users in a firm.

Administrative responsibility for users and documents is preferably partitioned between SYSOP and the firms, so that the firms have an appropriate degree of control over their own data. Each firm preferably designates a group of users who have authority to administer certain embodiments of the users enrolled by the firm and the documents originated by the firm.

Administrative functions in which firms participate preferably include: user naming, access control and billing. Referring more particularly to user naming, a TTP system according to an embodiment of the present invention denotes each user by a unique combination of a firm name and an individual name. The SYSOP preferably manages the names of firms, while each firm preferably manages the individual names of its users. Referring more particularly to access control, according to an embodiment of the present invention the TTP system controls access to data in the system. The SYSOP assigns to each firm authority to administer access control for its own users and documents. Referring more particularly to billing, according to an embodiment of the present invention a SYSOP preferably bills for actual usage of the TTP system. For each of the users it enrolls, a firm designates either itself or another party as the entity to be billed for the TTP services rendered to the user.

According to one embodiment of the present invention, responsibility for authentication of a user can be shared between SYSOP and one or more authenticating entities. An authenticating entity may also be a subscribing entity. For example, a licensing authority may arrange with a SYSOP to serve as an authenticating entity for an association of licensed professionals, and a firm may arrange with SYSOP to enroll some of these professionals, plus some of its clients, as users of the TTP system. In addition to its role as a subscribing entity, the firm serves as an authenticating entity, assuming greater authentication responsibility for the clients than for the professionals.

According to an embodiment of the present invention, confidential and collective identities may require other authentication arrangements. For example, some users of the TTP system (for example, clients or witnesses) may require that their identities be kept confidential. A firm can preferably enroll such a user with a SYSOP under an alias. The user confides its true identity only to the firm. Further, a subscribing entity may wish to enroll a collective party (for example, a corporation) with a SYSOP under its collective name; the subscribing entity may itself be the collective party. The subscribing entity ensures that only appropriately authorized individuals use the TTP system on behalf of the collective party. In both of the above cases, SYSOP will have a limited share of responsibility for authentication and the subscribing entity will have a large share.

A document may be any electronic file that can be transmitted through the web or e-mail. Hence, a document need not be textual, and it may contain any kind of information. The contents of a document are preferably treated as opaque data and are preferably not interpreted or modified by the TTP system.

A primary purpose the TTP system is that it enable users to send and receive documents conveniently and securely. From a web browser or an e-mail application, a sender submits a document to the TTP system. The send may specify one or more recipients for the document, at or after the time of submission. The TTP system will forward the document to the recipients, using the web-based or e-mail-based transport preferred by each recipient.

The TTP system preferably provides senders with an intuitive and convenient way to specify recipients. The system preferably does not require senders to be aware of the transport preferences of recipients.

The TTP system preferably enables users to query the status of delivery, receipt, and storage of a document. The document tracking function allows users to monitor the flow of a document while transmissions are pending and to ascertain the disposition of a document after transmission or storage.

The ability to track the flow of a document is preferably subject to access control, as document flow information will be considered confidential. By default, only the user who originates a document preferably has access to document flow information. If desired, that user or the administrators of the originating firm are able to ease access control; for example, the originating user may choose to enable tracking of a document by any other user in the firm.

The TTP system preferably enables the storage and archival of documents. A short-term storage capability is preferably used to support the document transmission function (for example, when a delivery is via web download or when a delivery via e-mail fails and is preferably retried). In addition to this capability, the TTP system preferably supports long-term storage and archival of documents. A SYSOP can offer these services as added value at extra cost, for example.

A short-term on-line storage period, needed to enable document transmission, applies to every document, according to an embodiment of the present invention. (A system-wide default for this period may be established, and firm-specific or user-specific values could override the default.)

According to one embodiment of the present invention, upon expiration of the short-term storage period, any deliveries not yet completed are abandoned, and errors will be reported; if no long-term on-line storage has been requested, and if any requests for off-line archival have been satisfied, the document is deleted. According to an alternative embodiment of the present invention, the TTP system implements an on-line long-term storage service, whereby a document is retained on disk in the document database and made available to authorized users for tracking, searching, retrieval, and other operations. Retention is preferably for a period specified by the document originator, and upon expiration of that period, the document will be subject to deletion. Further, users can be notified of imminently expiring documents and could be given the opportunity to extend storage.

According to an embodiment of the present invention, the TTP system implements an off-line archival service, whereby selected documents are archived to permanent retained media, from which they can later be restored. (This service is preferably distinct from backups that a SYSOP may perform as part of system maintenance; those backups saving all data in the system to rotated media, for example.) Archival could be specified as a simple yes/no choice by the originator of a document at the time of submission, for example.

The TTP system preferably enables the long-term retention of document flow data, either on-line or off-line, since this information may be needed months or years after a document transmission to craft a non-repudiation proof. In some cases, a non-repudiation proof may require both document flow data and the document itself (for example, to re-verify signatures). To enable such a proof, the document itself may be retained either by the user or by a SYSOP storage or archival service, while the TTP system retains public keys used for verification.

According to an embodiment of the present invention, the TTP system offers a search function to users, to facilitate the selection of documents for tracking, forwarding, or retrieval. Search capabilities can be simple and/or advanced. A sophisticated search function may enable bounding, selection, and sorting based on a range of parameters such as the document name, the names of sending or receiving users, the contents of various billing or annotation fields, and time. According to one embodiment of the invention, Searching does not extend to the actual content of a document, as the content may be encoded in a format that is specific to an application or is otherwise opaque. Upon completion of a search, the TTP system preferably returns a list of documents that satisfied the conditions of the search to the user, and the user is then be able to use this result to initiate a tracking, retrieval, or other operation. The TTP system preferably applies access control to ensure that the search facility returns only information that the user is authorized to see.

According to an embodiment of the present invention, the TTP service may be transmitting or storing documents in file formats that are specific to particular applications. For example, a textual document that was written in one word processing application may not be readable in another application. A receiver of the document is preferably able to consume such a document by opening the file from a particular application (and perhaps only from a particular application or version of the application on a particular platform). By preserving any document it receives, the TTP system thereby preserves any information about the type of a document that is embedded in it. The TTP system also preferably attempts to preserve any type information that may be implicit in the file name (such as a file name suffix). As will be evident to one possessing an ordinary skill in the art though, preservation of file names may not always be possible; the TTP system or other intermediaries may manipulate names to satisfy naming constraints or avoid naming collisions.

The TTP system preferably enables a user to register capabilities or preferences for applications and platforms and enables other users to look up this registered information. However, the system preferably is not required to validate such information, to validate that a recipient has the application and the platform appropriate for a document, to store names or copies of applications and platforms, or to perform conversions of document formats.

Users may wish to create various logical associations of documents, such as successive versions of a document or aggregations of related documents. According to an embodiment of the present invention, the TTP system supports operations such as transmission, storage, retrieval, or access control on these sets of documents as well.

According to an embodiment of the invention, a user can be associated with a document either as a sender or as a receiver. Each document is preferably associated with exactly one sender, the user who submitted the document. However, a document may have several receivers, the users who were named as receivers by the sender. According to an embodiment of the invention, the sender of a document is preferably able to view the document, track it, and view its history. Similar modes of access can be granted to other users within the same firm as the sender, for example. Defaults for such access should be configurable through an inheritance mechanism that applies throughout the hierarchy of documents originated by each firm. Similarly, a receiver of a document is preferably able to view the document but not to track the document or view its history. The ability of a receiver to view a particular document does not imply the ability to view other information such as its ancestors in the document hierarchy or its access control data, according to an embodiment of the present invention.

The TTP system is preferably designed to accommodate user preferences for transports (e.g., for web-based versus e-mail-based communication). It should be recognized that users need not be aware of the preferences or capabilities of other users though. Support for web-based access via off-the-shelf web browsers, using the Secured Socket Layer (“SSL”) protocol as a secure communications protocol, and for e-mail-based access from commercial e-mail applications, using Pretty Good Privacy (“PGP”) or Secure/Multipurpose Internet Mail Extensions (“S/MIME”) as the protocol is preferably provided. Any transport supported by the TTP system preferably enables strong authentication, data confidentiality, and data integrity, to ensure adequate protection of all documents transmitted to or from the system though. Some transports may offer additional security capabilities that the TTP system should exploit; for example, if an e-mail transport allows users to sign messages, the TTP system should store the signed data for potential later use in a non-repudiation proof.

It should be recognized that not all functions of the TTP system will be naturally expressible through all transports though. For example, delivery of a document via e-mail is a straightforward operation, but delivery in the web-based paradigm may require the TTP system to issue a notification by e-mail for example, so that the recipient will know to download the document via the web. Conversely, while the menus and forms in a web-based interface are well suited for functions such as tracking, storage, retrieval, and search; much of this functionality may be cumbersome in an e-mail interface. That being said, the primary functions of sending and receiving documents are preferably available via both e-mail and web interfaces. However, other functions may be restricted to the transports that are best suited for them.

The TTP system preferably also offer user interfaces for various other services, such as registering new users, requesting certificate renewals or revocations, and setting access control.

Parties who interact with the TTP system, whether users or administrators, are preferably strongly authenticated. An authentication infrastructure based on public key technology enables the TTP system to support the security mechanisms used by a large body of commercial software and to be consistent with emerging legislation on electronic messages, transactions, and signatures. The SYSOP preferably acts as the root Certification Authority (“CA”) for the public key infrastructure. The SYSOP may operate branded CAs on behalf of professional associations or other organizations, and these CAs will be subordinate to the original root CA. SYSOP may also establish trust relationships between its CAs and authorities in other CA hierarchies.

Because authentication through this public key infrastructure will not be possible for all transports, the TTP system preferably accommodates other authentication mechanisms. For example, to support PGP users, the TTP system preferably provides for management of their PGP public keys.

The TTP system preferably controls access to the data by regulating users, documents, document flow, and system operation. Authority and responsibility for setting access control is preferably divided between the SYSOP and the firms that subscribe to TTP services. Firms are preferably responsible for managing access control within their own hierarchies of users and documents. The SYSOP is preferably responsible for initializing these hierarchies, defining initial protection and inheritance data, and defining a group of users designated within each firm that will have administrative privileges. According to an embodiment of the present invention, the system supports default rules that will satisfy most user needs with little or no customization.

The TTP system preferably protects documents, through conventional cryptographic techniques, while they are transmitted to or from the system over open channels such as the global interconnection of computers and computer networks commonly referred to as the Internet. This enables the TTP system to provide confidentiality of document transmissions involving the system and its users. An illegitimate party eavesdropping a transmission is preferably not able to easily discern any of the transmitted content by implementing these cryptographic techniques. However, according to an embodiment of the present invention, this confidentiality does not apply when the TTP system issues a notification—that a document is available for retrieval, that a delivery has failed, or that a certificate is about to expire, for example. In particular, a user who uses protected web access to retrieve documents is preferably able to use unprotected e-mail to receive notifications, for example. Notification messages are preferably generic, so that they do not disclose any sensitive information.

Documents are also preferably cryptographically protected while they are stored on-line in the TTP system. In addition to the confidentiality provided by access control, the TTP system preferably encrypts documents when they are stored on-line, to prevent exposure in the event of an intrusion or an inappropriate use of privileges by a system operator. The system preferably decrypts a stored document only when necessary for an operation such as delivery to a recipient or backup, so that the plain-text form of the document is present only transiently on the TTP system.

The TTP system preferably encrypts documents when they are backed up or archived. The system preferably decrypts a backed up or archived document only when the document is restored.

The TTP system preferably ensures the integrity of document transmissions involving the system and its users. Each transmission is preferably verified in a way that detects tampering. Preferably, the integrity requirement also does not apply to notifications. The TTP system preferably ensures the integrity of documents while they are stored on-line. An integrity check is preferably conducted when a document is stored and is verified each time the document is accessed. Further, documents are also preferably cryptographically protected while they are stored off-line in archives and backups. Again, the TTP system preferably ensures the integrity of documents while they are stored off-line in archives and backups. An integrity check is preferably included when a document is backed up or archived and is preferably verified when the document is restored.

A non-repudiation capability provides assurance that a correspondent who participates in a communication cannot later deny having done so. This assurance is in the form of proof that one party can use as protection against false denial by another party. A proof may depend on data such as timestamps, digital signatures, and log files, for example. Non-repudiation can extend to several phases or embodiments of a communication according to an embodiment of the present invention. The TTP system preferably enables non-repudiation with proof of origin, proof of submission, proof of delivery, and proof of receipt. In each case, the system generates and/or retains data about document transmissions to enable as strong a proof as is practical. However, it should be recognized that the strength of proof that is achievable might be limited by factors such as the data that the transports can produce and the data that users choose to yield. The TTP system may sometimes be able to generate only a weak proof, for example.

According to an embodiment of the present invention, the TTP system uses a proof of origin to establish the identity of the originator of a document. The TTP system preferably provides data to associate a document with the particular user who submitted it. Proof of submission establishes that a document was submitted by a party to a delivery service and was accepted by that service. The TTP system preferably provides data to demonstrate the uploading of a particular document onto the system. Proof of delivery establishes that a document was delivered to a party. The TTP system preferably provides data to demonstrate the delivery of a document to a particular recipient. It should be understood that the meaning of “delivery” in this context may depend on the behavior of the particular transport service used to convey the document between the TTP system and the recipient. Proof of delivery may be provided by logging the retrieval of the document by the recipient. Proof of receipt establishes that a party has taken receipt of a delivered document. As with delivery, the meaning of “receipt” may depend on the behavior of the particular transport service used. Typically, a strong proof of receipt requires the cooperation of the recipient, because the recipient typically gains possession of a document before yielding proof. The TTP system preferably retains any such proof that a recipient yields. The non-repudiation capabilities described above establish the fact that a party took a particular action with respect to a particular document.

According to an embodiment of the present invention, a timestamping service is used to enhance these capabilities by establishing the time at which such an action occurred. Trusted timekeeping and timestamping can also advantageously be used to enhance the integrity and manageability of the public key infrastructure, the user database, the document database, and the logging and billing subsystems. The timestamping service in the TTP system preferably issues timestamps that are accurate to within some predetermined temporal period, such as one second. According to an embodiment of the present invention, the drift found in the clocks of many computer systems, which can be several minutes per month, may be therefore unacceptable, and the TTP system preferably assures accuracy by reference to another time source. The time source is preferably stable enough to maintain one-second accuracy over a period of one to ten years with little or no operator intervention, for example. Further, to maintain data integrity, the sequence of timestamps generated by the TTP system preferably progress monotonically, so that the order of events in all document flow data is correct. If the time source is external to the TTP system and accessed via dialup, network, or radio for example, then dependencies on continuous connectivity and exposures to spoofing or jamming attacks should be reasonably minimized.

The TTP system itself is preferably designed and deployed in a way that prevents (to the extent practical) unauthorized access to TTP data, compromising the integrity of the data, or denying TTP services to users. Measures to detect a compromise are also preferably provided, so that security can be monitored and demonstrated. Hosts that provide document handling services are preferably protected by one or more firewalls that restrict access via the supported web and e-mail transports. Hosts that sign and issue certificates preferably exhibit strong protection. Hosts that perform registration functions may also be protected by a firewall, for example. Protection of the private key for the root CA itself is particularly critical; storage for the key should be highly resistant to tampering.

Deterring or countering denial-of-service attacks may also be important for particular implementations of a TTP system according to the present invention that allows access via the Internet, such as the document handling server. In such a case solutions can be adopted to at least mitigate this risk. To assist in the detection of possible compromise, automated mechanisms to check the integrity of the TTP system are preferably deployed.

According to an alternative form of the present invention, a SYSOP can enhance its authentication services by issuing cryptographic tokens such as smart cards to users. Such smart cards can serve as tamper-resistant storage for private keys and enhance the security of the user platform in other ways (for example, by integrating with a screen-locking utility to prevent unauthorized use of the computer while unattended). Further, a community of users, such as a professional association or a corporation, may use these smart cards both as ID cards and as tokens for accessing TTP services.

There are no absolute constraints on the hardware platforms and operating systems that users can use, since no executable software is preferably installed on these hosts. There are no absolute constraints on the hardware architectures or operating systems for the platforms on which the TTP system is deployed. However, the platforms selected are preferably among those widely used in mission-critical business environments, so as to ease the integration of third-party products and services (such as for boundary protection, system maintenance, high availability, and upgrades of performance or capacity) into the TTP system. According to an embodiment of the present invention, users are not required to install application specific software on their hosts. The TTP system instead preferably leverages common off-the-shelf software, such as web browsers like Internet Explorer available from Microsoft and Netscape Navigator available from Netscape, and e-mail applications such as Groupwise available from Novell or Outlook available from Microsoft, that are likely to be present already on many user hosts. According to an embodiment of the present invention, web-based interfaces should avoid reliance on plug-in modules, which may not always be available for all user platforms, although this is a matter of design choice. Users should not be required to download active content, such as Java or JavaScript programs, onto their hosts. However, platform-independent and non-executable data, such as public key certificates and cookies, may be downloaded onto user hosts to enable security services or state management.

However, it should be recognized that some requirements for client application software will necessarily be imposed on users. For example, web browsers may be required to support particular versions of the HyperText Markup Language (HTML) and SSL protocols, or e-mail applications may be required to support a particular version of the PGP or S/MIME protocols. The architecture is preferably adapted to specify a TTP system that accommodates a broad range of user preferences and inter-operates with a broad range of popular off-the-shelf applications.

A TTP system according to the present invention preferably provides mechanisms for managing user account information. Operations preferably include: creation of a user account, including the issuance of user certificates; revocation and/or rollover of certificates; deletion of an account, including the revocation of certificates; and management of auxiliary user data, such as billing defaults, storage defaults, and transport preferences. Many of these operations require the participation of both users and the SYSOP staff. The SYSOP preferably defines the procedures whereby users request accounts, renew certificates, report key compromise, and so forth. Special cases such as confidential or collective identities can also be supported. Agreements between SYSOP and the firms will specify the respective responsibilities of the parties for certification and management of users.

As will be recognized by one possessing an ordinary skill in the pertinent art, groups, and their associated privileges, are the vehicle by which administrative responsibilities are partitioned between SYSOP and the firms. The TTP system preferably provides mechanisms that both SYSOP staff and the designated administrators in each firm can use to create groups and to manage group memberships. The TTP system preferably provides tools and information that SYSOP staff can use to diagnosis and repair problems that users experience. The critical subsystems of the TTP system preferably emit diagnostic messages to persistent logs. Ideally, the level of detail will be adjustable and a unified view of the logs is available.

A TTP system according to the present invention preferably allows for regular automated backup of system and user data. Ideally, backups cause little or no interruption or degradation of TTP services, especially if run at times of low activity. However, the integrity of the backup image is paramount, and if necessary, quality of service can be compromised to enable an internally consistent backup. Likewise, a TTP system according to the present invention preferably allows for the restoration of data from backup media, either in small sets such as single documents (in the event of accidental deletion by a user) or in large sets such as all system and user data (in the event of a catastrophic failure).

A SYSOP is preferably able to monitor the quality of service being delivered by the TTP system and to detect performance problems, resource utilization problems, and error conditions. The TTP system and the operating systems on the TTP system platforms generate raw data on performance and resources, and monitoring tools will analyze the data, produce regular reports on quality of service, and notify SYSOP staff via an alert mechanism of conditions that require attention. A TTP system according to the present invention is preferably highly reliable, so that service interruption and data loss are minimized, to the extent achievable at reasonable cost.

According to an embodiment of the present invention, a SYSOP can bill for a range of TTP services, optionally including document transmission, document tracking, long-term document storage and archival, and generation of non-repudiation proofs. Therefore, the TTP system preferably enables a SYSOP to bill a firm for any TTP services that it or its users request. According to an embodiment of the present invention, the TTP system also enable a SYSOP to bill a user directly rather than a firm. Direct billing of a user can be predicated on arrangements among the user, the firm, and SYSOP. For example, a firm may allow an employee to make personal use of the TTP system, and the employee may arrange with SYSOP for payment by personal credit card. The TTP system also preferably generates information that firms can use to bill their clients, such as a billing label. When a user requests a TTP service, the TTP system preferably associates the request with billing information, such as a client account number or a matter number, which either the firm has specified for that user or the user has specified with the request. Together with the bills that the TTP system generates for each firm, the system also preferably generates itemized reports that include this information; which the firm can then use to bill its clients. The reports can be itemized according to the user and according to the billing information according to yet a further embodiment of the present invention.

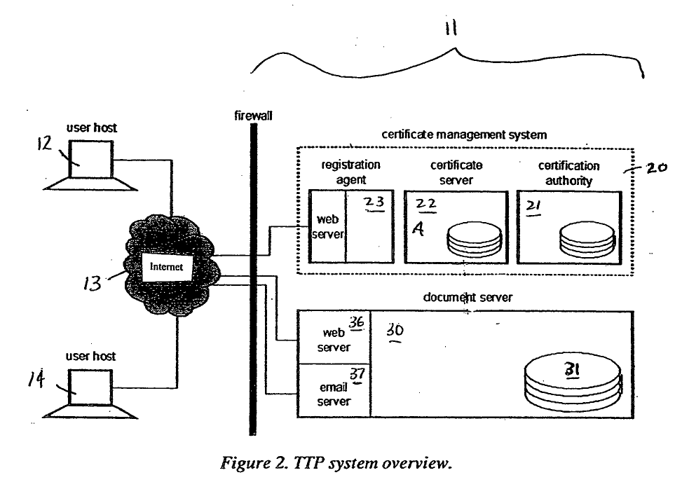

Referring now also to FIG. 2, an overview of the structure and functionality of a TTP system according to an embodiment of the present invention is set forth, and further described in more detail. The TTP system 11 preferably includes a Certificate Management System (CMS) 20 and Document Server 30, each of which in turn contain several components. As set forth, users 12, 14 preferably access the TTP system 11 over the Internet 13 using web browsers and e-mail client applications. The SYSOP preferably administers the TTP system 11 both via the web access and through direct access to system hosts.

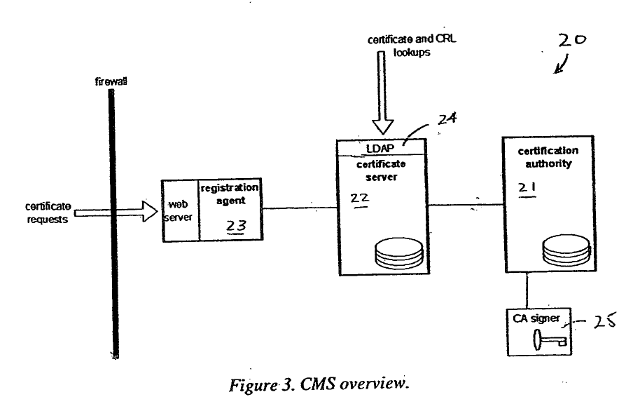

Referring now also to FIG. 3, according to one embodiment of the present invention the CMS 20 includes several UNIX hosts: a CA server 21 that issues certificates and certificate revocation lists (CRLs) in combination with a CA signor 25; a certificate server 22 that communicates with the CA server 21, maintains a current database of certificates and CRLs and provides a Lightweight Directory Access Protocol (LDAP) interface 24 through which other components can query the database; and one or more registration agents 23 that handle certificate requests. The CMS 20 may take the form of the commercially available Cybertrust product from GTE.

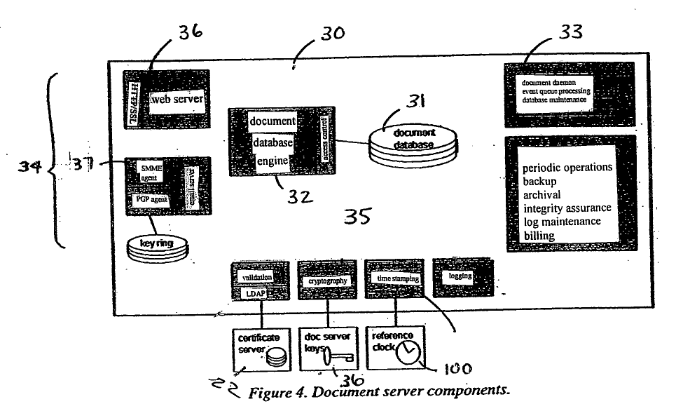

Referring now also to FIG. 4, the Document Server 30 may reside on a single UNIX server. According to one embodiment of the present invention the major components of the Document Server include: a document database 31 that stores documents, information about past and pending operations on documents and information about users 12, 14; a database engine 32; a document daemon 33; transport modules 34 and infrastructure components 35. Referring more particularly first to the documents database 31, documents are preferably organized into a hierarchy of categories while users are organized into a hierarchy of groups. The database engine 32 manages storage and retrieval of information in the database 31. The database engine 32 applies access control to operations on the database 31. The document daemon 33 initiates execution or retry of pending operations on documents and performs database maintenance tasks such as reaping of files that are no longer needed. The transport modules 34 include a web server 36 and an e-mail server 37—that convey requests from users 12, 14 to the database engine 32 and convey responses from the database engine 32 back to users 12, 14. And, the infrastructure components 35 provide services such as cryptography (in combination with keys 36), validation (in cooperation with the certificate server 22), timestamping (in combination with clock 100), logging, billing, integrity assurance, backup and archival. Some of these components can be libraries that document server 30 component calls as is necessary, for example. Others can take the form of daemon processes that run in the background or at regular intervals, for example.

TTP CMS functions handle public key certificates on which TTP authentication is based. These functions include: handling certificate requests; issuing certificates; rolling certificates over, so that the expiration of one certificate and its replacement by another does not disrupt legitimate access to the system; deleting users; revoking certificates, either due to deletion of a user or due to a reported key compromise; and issuing certificate revocation lists.

The CMS preferably retains management information about all certificates and CRLs that it issues, beyond times of expiration or revocation. The CMS also provides LDAP directory interfaces that Document Server components can use to retrieve current certificate and CRL data.

Users preferably request TTP document handling services through a set of Document Server user functions. Only limited services are preferably available through the e-mail transports, while additional services are preferably available through the web transport. The ability of a user to invoke a function, and in some cases the data returned by a function, can be contingent on the authorization of the user, as defined and enforced by the Document Server access control mechanism. The TTP document transmission functions may require multiple steps, which may be performed by senders, by receivers, and by the Document Server. The transport preferences of users preferably determine which functions are available to them and influence how the Document Server performs its steps. According to an embodiment of the present invention, Web users are able to initiate the following document transmission functions by submitting web forms to the Document Server: STORE, which uploads a document into the document database; FORWARD, which instructs the Document Server to deliver an uploaded document to one or more recipients; SEND, which combines the STORE and FORWARD functions into one, allowing a user to upload a document and specify recipients in a single web form; and RETRIEVE, which will download a document from the document database. The document will be placed in a specified location and possibly also opened by a specified application on the user desktop.

E-mail users are preferably able to initiate the following document transmission functions by sending an e-mail to the Document Server: SEND, which uploads a document into the document database and instruct the Document Server to deliver the document to one or more recipients (in e-mail to the Document Server, the sender preferably specifies recipients in the body and include the document as an attachment); and STORE, which uploads a document into the document database (for an e-mail user, a STORE is preferably a SEND with no recipients specified). The Document Server will perform the following document transmission functions: DELIVER to a web user will be a notification via e-mail, advising the user to perform a RETRIEVE; and DELIVER to an e-mail user will be a direct transmission via e-mail, including the document as an attachment. In addition to the above basic functions, both the TTP system and its users, when acting as recipients of documents, are preferably able to acknowledge receipt. The Document Server preferably offers a facility to look up the names of users, so that, for instance, the sender of a document can reliably and unambiguously specify the recipients of the document. LOOKUP in the web interface is accomplished through lists of firms and users, which the Document Server constructs and displays to the user in menus. LOOKUP in the e-mail interface is accomplished through exchanges of e-mail, whereby a user submits lookup requests and the Document Server returns current lists of firms and users.

It should be recognized that while a lookup via e-mail may not offer ideal usability or responsiveness, this function is preferably available in some form. In practice, users who send documents via e-mail may prefer to look up users via the web, and thus a web form that assists in the construction of e-mail messages may be provided. Further, an additional lookup query, given the name of a user, preferably returns any capabilities or preferences for applications that the user may have registered.

According to an aspect of the present invention, the e-mail interface system may be based on the Simple Mail Transfer Protocol (SMTP). A platform-independent, Java-centric environment, such as Java 2 Platform Enterprise Edition (J2EE) Software Development Kit (SDK), can be used to provide a set of classes and interfaces, which provide an application layer interface to the SMTP.

According to an aspect of the present invention, the e-mail interface system may make extensive usage of classes, such as follows: 1) a session may be created and used to access Store and Transport objects of the mail server; 2) a Store class provides mechanism for connecting messaging server folders; 3) an INBOX folder provides mechanism for retrieving messages stored in the inbox; 4) the Transport provides a mechanism for sending messages; 5) a MimeMessage provides e-mail message representation; and, 6) a PGPMessage provides e-mail message representation. Of course, MIME stands for Multipurpose Internet Mail Extensions, while PGP stands for Pretty Good Privacy, as both are conventionally understood.

According to an aspect of the present invention, the e-mail application processes incoming email messages, sends abandoned data e-mail messages to users who originate data distribution requests, sends e-mail certificates to newly registered users with the e-mail delivery preference, and sends storage consumption exceed messages to organization administrators, for example.

According to an aspect of the present invention, the e-mail application executes associated use cases periodically, such as on an hourly interval (hourly on the hour).

According to an aspect of the present invention, the authentication module is executed when a user initially accesses the system. According to an aspect of the present invention, two-factor authentication may be required: (1) a system issued private key certificate, and (2) a user account password. According to an aspect of the present invention, the authentication module may perform certificate authentication function automatically, while password authentication is performed only following success of certificate authentication. According to an aspect of the present invention, the authentication module validates the password applied by the user.

Following password validation, a system member list provides methods for querying a databases and returning collections of directory objects. Directory objects include attribute information about users, for example. User attribute information includes, for example, public/private key preferences such as e-mail representations, e.g. MIMEmessage or PGPmessage.

According to an aspect of the present invention, the system provides methods for accessing public/private keys and accessing session encryption keys.

In other words, and by way of a non-limiting example, according to an aspect of the present invention, if a user who has designated PGP as an attribute (PGP User) wants to send a protected communication to a user who has designated S/MIME as an attribute (SMIME User), for example, the PGP User encrypts the communication using a PGP and a public key associated with the trusted third party, or system. The trusted third party, using a corresponding private PGP key for example, decrypts the communication. The trusted third party identifies the S/MIME User as the intended recipient of the communication and, using an S/MIME public key associated with the S/MIIME User, encrypts the communication. The S/MIME user can than merely decrypt the communication using an associated private key.

According to another aspect of the present invention, one or more of the users may designate both PGP and S/MIME capabilities, in which case any common scheme can be employed, for example.

According to an aspect of the present invention, security audit procedures apply to the PGPMime to S/MIME interchange and serve to provide additional assurance that the TTP did not tamper with the communication.

Web users are preferably able to track the progress or the history of a document, during or after transmission or storage. TRACK causes the Document Server to retrieve from the document database the history of operations on a specified document, then to display the history in human-readable form. A user can preferably invoke a TRACK by opening the document of interest and clicking on a button.

Web users are also preferably able to browse the document database, navigating through the document hierarchy by opening categories and documents. An OPEN command in the hierarchy preferably causes the Document Server to display a view of that category, which will include descriptive information, links to related objects, and buttons to invoke various administrative operations. An OPEN command on a specified document in the hierarchy preferably causes the Document Server to display a view of that document, which preferably includes descriptive information, links to related objects, and buttons to invoke operations such as DOWNLOAD, FORWARD, TRACK, and administrative operations. A user can preferably specify an object either by entering an explicit Universal Resource Locator (URL) or by clicking on a link, for example.

Web users are preferably able to search the document database for documents that meet various criteria. A search facility helps users to locate documents on which they may then wish to perform retrieval, tracking, or other operations. SEARCH causes the Document Server to search the document database according to specified criteria, then to display links to documents that satisfy the criteria. A user invokes a SEARCH by clicking on a button to bring up a search form, entering the search criteria in the form, then submitting the form. Criteria for searching can include names of documents, names of sending or receiving users or firms, keywords or other annotations, billing information, and times of submission or receipt, for example.

Documentation is preferably made available to assist users of the TTP system. This documentation preferably includes HELP in the web interface which is available through help buttons, which in turn cause the Document Server to display online documentation. It also includes HELP in the e-mail interface which is preferably will be accomplished through an exchange of e-mail, whereby the user submits a help request and the Document Server returns a summary of the syntax for operations available in the e-mail interface. Any e-mail request that the Document Server cannot parse will return an error as well as a syntax summary.

Other miscellaneous operations are preferably available to web users, such as: modifying annotational information for documents such as abstracts and keywords; modifying parameters that determine storage or archival services for a document; modifying billing information for a document; and copying, moving, or deleting documents in the database. Users preferably invoke these operations through buttons and/or forms.

Administrative functions define access control in the document database and support the operation of the Document Server. Administrative functions that pertain to user groups, document categories, and access control are available both to SYSOP staff and to designated staff in each firm. These functions include: creating and deleting user groups; defining the membership of a user group; creating and deleting document categories; and setting access control by users or groups to documents or categories. SYSOP staff largely administer the top levels of the user and document hierarchies, defining for each firm a tree within each hierarchy for its own users and documents. Designated staff in each firm has administrative access only to the tree allocated to that firm.

SYSOP staff perform a number of routine operational tasks, including: backing up of software and data in the TTP system; archiving data that requires long-term retention; and billing operations. These tasks are preferably largely automated but will require some action or attention from system administrators.

The primary basis for authentication in the TTP system is a Public Key Infrastructure (PKI), for which the SYSOP acts as the certification authority. A certificate, in the format defined by the ISO X.509 v3 standard for example, binds the identity of each user to a public key. A certification authority operated by SYSOP preferably attests to this binding by digitally signing the certificate. The SYSOP CA is preferably a root CA, and its certificate is self-signed. According to one embodiment of the present invention, the SYSOP operates only as the root CA. Alternatively, the infrastructure can be expandable to a hierarchy of authorities operated by SYSOP, with the original CA as the root. It should be recognized that a single deployment of CMS hardware and software will preferably be capable of implementing several CAs and switching dynamically between them.

Each operator and each user of the TTP system has a public key identity that is established in one or more X.509 v3 certificates. These certificates are issued by the SYSOP root CA, by a CA subordinate to the SYSOP root, or by another CA trusted by SYSOP, for example. The TTP system is therefore able to validate any user certificate and establish trust by traversing a hierarchy of certificates. A user who accesses the TTP system via more than one transport may need a separate key pair and certificate for each, because the various applications that the user employs may not be able to access a single certificate. In addition, transports may require the use of different key pairs for different functions (e.g., for signing and encryption). All of these certificates preferably denote the same identity.

The subject field of each certificate preferably specifies the X509 distinguished name (DN) for a user. A DN identifies a unique user. That is, no two users should have the same DN, although one user may have several DNs and one user may have several certificates with the same DN. Through its registration processes, a SYSOP preferably ensures the uniqueness of DNs can be relied upon within the set of CA hierarchies that SYSOP operates or otherwise trusts. Some of the certificate fields important to the TTP system are: version, issuer, validity and subject. Typically, version 3 is used to enable the use of extensions required by SSL and other protocols. The issuing authority is a CA within a hierarchy operated by SYSOP or otherwise trusted by SYSOP. The period for which the certificate is valid is used by the SYSOP and firms to establish policies for validity periods; and a firm may request validity periods of different lengths for different users. The DN is used to identify the subject of the certificate.

The X.509 certificates are preferably managed by and stored in a directory in the CMS. The CMS, the transport mechanisms, and the Document Server preferably use Lightweight Directory Access Protocol (LDAP) interfaces to access the certificates. Certificates issued by the CMS follow the certificate profiles required by S/MIME, SSL, and other protocols, as necessary. The private key associated with each certificate is preferably protected by the user and preferably shouldn't leave the user desktop. (The key might be stored on disk and protected by a password, or it might be stored in a token such as a smart card.) In the case of the SYSOP root CA identity, the private key is preferably stored off-line in a tamper-resistant hardware device.

The SYSOP operates the Certificate Management System (“CMS”) that issues certificates and certificate revocations. Tasks carried out by the SYSOP staff include processing certificate requests, processing notifications of key compromise, and managing the rollover of imminently expiring certificates. The SYSOP assumes significant responsibility for the certification of human identities (for example, establishing that a certificate request claiming to be from John Doe really is from the human being named John Doe). In some cases, as discussed earlier, the SYSOP may distribute significant responsibility to the authenticating entities and subscribing entities with which those users are associated. Policies and procedures for issuing and revoking certificates are preferably set and followed by the SYSOP. A certificate policy outlining the responsibilities of subscribers is also preferably presented. SYSOP ability to support the certificate policy is preferably documented in a certificate practice statement, which is made available to SYSOP's liability agents and, possibly, to SYSOP's subscribers.

Users are preferably responsible for generating their pairs of private and public keys, initiating certificate requests, and protecting their private keys. The means for executing these tasks are typically provided by applications such as web browsers or e-mail clients. Users also preferably notify the SYSOP if a key is lost, disclosed, used without authorization, or otherwise compromised. The use of a certificate issued by SYSOP preferably implies acceptance of SYSOP's certificate policy.

A SYSOP may allow firms to implement their own user-registration and key-distribution procedures, some of which will impose particular responsibilities on the firms. For example, a firm may authorize one of its administrators to generate key pairs and initiate certificate requests for all of its users, using an existing database as input for bulk registration for example. The administrators would then be responsible for securely transferring private keys to the users. A firm may also authenticate users who participate in the TTP system under a confidential or collective identity. In such a case, the firm then assumes any additional risks posed by alternative registration procedures.

The Document Server preferably manages a relational database of information about documents and users, controls access to this information, and performs many of the document operations requested by users. The document database is central to much of the core functionality in the TTP system. The Document Server stores its own information about users, separate from the user information in the CMS. Associated with each user in the document database is a profile of information that is used by the Document Server when it execute operations that involve the user. Within the Document Server, each user is denoted by a unique combination of a firm name and an individual name. (The name might be constructed through a simple concatenation, perhaps borrowing from Internet e-mail naming the @ delimiter, as in “JohnDoe@AcmeCompany”). The SYSOP preferably ensures the uniqueness of firm names, at the time that each firm subscribes to TTP services. A firm preferably ensures the uniqueness within the firm of the individual names for its users, at the time that it enrolls each user.

According to an embodiment of the present invention, one correspondence between the Document Server and CMS databases is maintained for each user: the DN for the user in the CMS is stored in the profile for that user in the Document Server. This correspondence allows authentication for TTP system access to be based on public key certificates while Document Server functions employ simple user names. The simplicity of user names in the Document Server, as well as their incorporation of firm names and individual names, enhance the usability of functions such as setting access control and listing document recipients.

User profile information preferably includes: the DN of the user; the e-mail address to which documents and/or notifications should be sent; the transport by which the user prefers to receive documents; the e-mail transport by which the user prefers to receive notifications; the PGP User ID of the user, which can take the form of an Internet e-mail address if the user employs PGP as a transport; and, the party that SYSOP will bill for services requested by the user if a firm is not being billed. User profile information may also include: default billing labels for services requested by the user; default parameters for services such as document storage and archival; preferences or capabilities for document applications or formats; and, practical information such as mail addresses, phone numbers, and fax numbers. The user profile is also a potential vehicle for specifying authorization restrictions that may not otherwise be expressible in the Document Server access control framework (for example, allowing a client to exchange documents only with a particular attorney or firm).

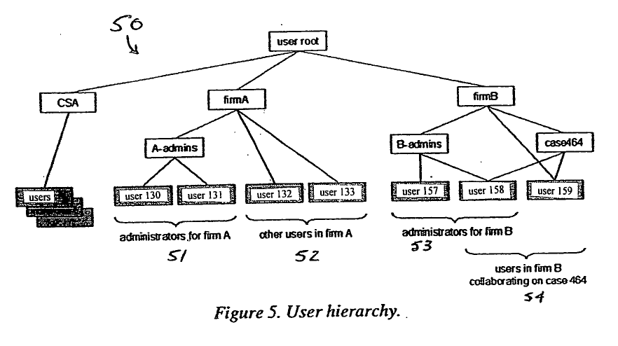

Referring now also to FIG. 5, users and groups in the document database form a hierarchy 50. The Document Server also advantageously enables the creation of user groups, e.g. user groups 51, 52, 53, 54. Each group preferably has a distinct name and a defined set of members; the members of a group may include individual users and/or other groups, e.g. user130 and user131 in the case of group 51 or user159 and group 53 in the case of group 54. Groups serve several purposes, for example the SYSOP can create a group for each firm. According to one embodiment of the present invention each user of the TTP system is a member of exactly one such group; this association of user to firm identifies the firm that bears certification and billing responsibilities for each user. These groups enable a SYSOP to ensure that each firm has access only to its own documents. Further, when a firm subscribes to TTP services, the SYSOP preferably creates a group of administrators within the firm. The SYSOP defines and control the membership of each such group, based on direction from an individual in each firm with appropriate authority for example. These groups advantageously enable the SYSOP to delegate some administrative responsibility to each firm. When a firm wishes to aggregate or differentiate access control for its own users, firm administrators preferably create groups of users who have common access control needs. For example, a firm may define a group that corresponds to a particular case; where all users working on the case would be members of a group for example, and are therefore given the same access to documents pertaining to that case. Finally, the ability to create a group and to define its membership is preferably itself subjected to access control.

Information about each firm is preferably stored in a profile in the Document Server database. This profile may include billing logistics such as account numbers and mail addresses. It may also include default values that specify services such as storage and archival for documents submitted by each firm.

Documents are preferably stored as objects in a relational database. Associated with each document is an event history, containing information about past operations on the document; an event queue, containing information about pending operations; and various ancillary data.

The database engine preferably calculates a hash or digest of each document when it is submitted and stores this value with the document in the database. The database engine also verifies this integrity check each time the document is accessed. The database engine further encrypts each document when it is submitted, stores the encrypted form in the database, and decrypts the document when it is accessed. The selection of encryption algorithms and key sizes are constrained by performance requirements, as these transforms directly impact the responsiveness of the system to user requests. Keys specific to this purpose are preferably controlled by SYSOP and protected against misuse by intruders or by operators.

Some transport protocols specify particular ways to encode transmissions, for purposes such as optimizing use of bandwidth or ensuring correct handling by transfer agents. (For example, PGP may perform compression, then perform a radix-64 encoding that represents data in a set of characters that mail gateways will reliably handle correctly.) The Document Server transparently accommodates such encodings, so that a document can be sent or received by several users employing several different transports, without the users being aware of the differences. A document will generally be stored in the database in a transport-independent format.

In some cases, a transport-specific encoding includes the digital signature of the user to whom a document, an acknowledgement, or another communication can be attributed. (For example, S/MIME v3 signed messages and signed receipts are encoded in a syntax that may not be meaningful to other mail protocols.) To enable later use of this signature in a non-repudiation proof, the Document Server stores the data, in event history, in its original transport-specific encoding.

A document, once submitted, preferably cannot be modified. However, a new version of a document can be submitted as a separate document, and the relationship between the documents can be made apparent through document naming and/or annotations.

Event data is preferably associated with each document as the TTP system processes the document. Each document operation (e.g., submission, receipt, or deletion) is preferably recorded as one or more discrete events. Completed events are preferably stored in a document event history; while pending events are preferably stored in a document event queue.

As will be evident to one possessing an ordinary skill in the pertinent art, some operations are simple, comprising a single event and returning a result immediately. For example, the deletion of a document is a relatively simple operation (it may not be, if archival tasks are pending for example). Such a simple operation, if successfully completed, is preferably recorded directly into the document event history. As will also be evident, other operations are complex, comprising multiple events, returning multiple results, and/or executing in a delayed fashion. Consider, for example, a document transmission from one sender to three receivers, which could comprise one submission from the sender to the TTP system, followed by an acknowledgement of submission from the TTP system to the sender, three deliveries from the TTP system to the recipients, and finally three acknowledgements of receipt from the recipients to the TTP system. Complex operations may require that information be recorded in both the event queue and the event history. Any events that execute immediately and successfully are preferably recorded directly in the document event history. Events whose execution may be deferred or protracted are preferably added to the document event queue, and the record for each event remains in the queue until the event either executes successfully or is abandoned. When an event executes successfully, the record is preferably deleted from the event queue and a new record is added to the event history. If execution of an event is abandoned, due to unrecoverable error or exhaustion of retries, the record is preferable deleted from the event queue and a record of the failure is added to the event history.

The data stored as a record of each event may include: the type of event (e.g., submission, acknowledgment of submission, delivery, acknowledgement of receipt, or deletion); the parties involved in the event (e.g., the sender and the receivers involved in a document transmission); data specific to the transport used for the event (e.g., the protocols used, the quality of protection applied, the certificates of the parties, any digital envelope created by a party, or any digital signature applied by a party); a timestamp applied by the Document Server to record the time of the event; and a signature applied by the Document Server to the document plus accumulated history data.

Data in event queues are preferably used by the Document Server to schedule and execute asynchronous operations, particularly those such as e-mail notifications that are subject to deferred, protracted, or periodically retried execution. Data in event histories is preferably used to generate results for document tracking requests and for non-repudiation proofs. The Document Server satisfies a document tracking request simply by presenting the event history of the document in a human-readable format. Non-repudiation proofs use a similar presentation, combined with the re-verification of any signatures and the retrieval of any associated log entries. The Document Server preferably stores, in addition to the event data described above, the several types of ancillary document data.

To help users navigate through the database and identify documents, the Document Server preferably stores annotational information about each document, supplied initially by the originating user at the time of submission for example. This information may include: an abstract of the document, which authorized users could view without having to download the actual file; and a set of keywords, which could be used by the document search facility.

A billing label is the vehicle by which a firm can input information that facilitates its own billing of its clients A billing label is preferably a printable text string, that may have meaning only to the user or firm that creates it for example, such as an account number, a client name or a matter number, or combination of these. A user may attach a billing label to a document at the time the user submits the document. If the label is omitted, or if the firm that enrolled the user is not permitting the user to dictate billing, then a default billing label in the user profile may automatically be attached to the document. Billing labels are preferably stored with each document as ancillary data and are emitted by the TTP system via log entries recording any billable operations on the document. Through the TTP billing service, this information is ultimately passed on by SYSOP to each firm, and the firms may use the information to perform their own billing.

To enable direct billing of a user by SYSOP, such as for personal use of the TTP system, the SYSOP may define a special format for a billing label, which could include a personal credit card number for example. This is an example of billing label that the TTP system will interpret rather than simply pass through.

With each document, the Document Server maintains information that records any storage or archival options that have been requested and/or fulfilled. The maintenance processes that perform document aging and archival examine this information to determine which documents require retention or archival.

The Document Server enables the creation of document categories. A category is an aggregation of documents that has a name and has as its contents individual documents and/or other categories. The documents and categories in the document database form a hierarchy, wherein the documents are leaves and categories are nodes. The document hierarchy is somewhat analogous to a file system; documents correspond to individual files and categories correspond to directories (as in UNIX) or folders (as in Microsoft Windows). A category and its contents may be thought of and referred to as a parent and its children, respectively. Document categories facilitate access control in the document database and navigation through the database. The ability to create a category and define its contents will itself be subject to access control.

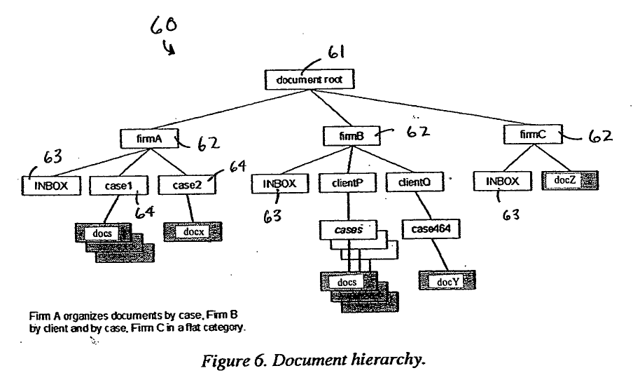

Referring now also to FIG. 6, at the top level of the document hierarchy 60 is a root category 61, over which the SYSOP has complete control. At the second level, just below the root 61, the SYSOP can create a separate category 62 for each firm, for example. Within its own category, a firm is preferably provided with an inbox 63 for documents it receives. Each firm can preferably organize the documents that it originates in any structure it wishes. Firms may wish to create categories 64 within their portion of the document hierarchy, to reflect patterns of usage and access control. For example, a firm may aggregate all documents pertaining to one case into one category 64, and it may also aggregate all the cases for one client into a higher category. The access control mechanism preferably ensures that users from one firm can see and touch only the objects within the category for that firm.

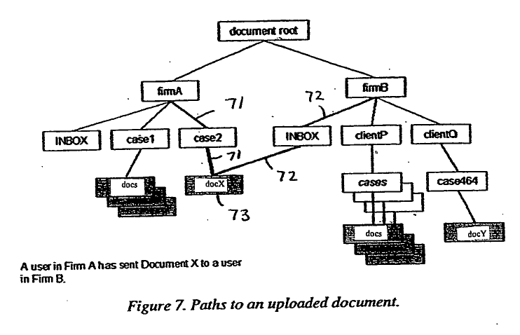

Referring now also to FIG. 7, unlike a typical file system hierarchy, the document hierarchy 60 (FIG. 6) according to an embodiment of the present invention preferably allows a document or a category to have more than one parent category. Hence, there can exist multiple paths, e.g. 71, 72, to a given document, e.g. 73, even though only a single instance of the document exists. This characteristic enables one copy of a document in the database to be accessible by both a sender and a recipient—that is, the path visible to the recipient will traverse the inbox of the receiving firm.

Users who interact with the TTP system via a web based interface can preferably navigate interactively through categories until they reach a specific document or category. Users who submit documents to the TTP via e-mail can use a path name to specify a document or category. The access control mechanism preferably ensures that a user can see a given path to a document only if that user has privileges to see every category in that path.

The Document Server preferably implements an access control mechanism to ensure that a user can perform on a document only those operations, if any, for which the user is authorized. Access control is the primary means for maintaining the confidentiality of documents while they reside on the system. In addition to documents, the access control mechanism preferably governs operations on other objects within the document database, such as categories, users, and groups. Preferably, access control in the Document Server does not rely on, nor will it be impacted by, the operating system security on the TTP service platforms.

Whenever a user requests an operation on an object, the access control mechanism renders a decision to allow or refuse the operation, by evaluating: who the user is; what level of privilege is required to perform the requested operation; whether the user has that level of privilege for that object.

Access control relies on strong authentication of the identity of the user; this authentication is preferably performed in the transport agents through the use of X.509 v3 certificates, for example. The transport agents pass the X.509 DN of a user to the database engine, which then uses the DN to look up the user name by which that user is represented in the document database. For PGP authentication, which does not use X.509 certificates for example, the PGP agent preferably uses public keys in a PGP key ring to authenticate users, and then pass the PGP user in to the database engine. Within the document database, users are preferably identified by their user names in all access control information.

The Document Server preferably defines several levels of privilege, including READER, AUTHOR, ADMINISTRATOR, and SUPER USER privileges, for example. Each level of privilege preferably enables particular operations on documents or other database objects. READER privilege is typically granted to recipients of a document. It allows a user to download the document from the database. READER privilege on categories allows a user to see and traverse those categories in the document hierarchy. AUTHOR privilege is typically granted to the submitter of a document. It allows a user to modify the access control on the document, to view the event history of the document, to modify the ancillary data of the document, and to delete the document. An AUTHOR privilege on a category allows a user to submit a document in that category. ADMINISTRATOR privilege allows users to perform general administrative functions, including those relating to user groups and document categories. A small set of users at a firm will typically be granted ADMINISTRATOR privilege on its users and documents. SUPER USER privilege is preferably granted only to certain SYSOP staff members. It allows a user to administer all embodiments of users, groups, documents, and categories throughout the document database.

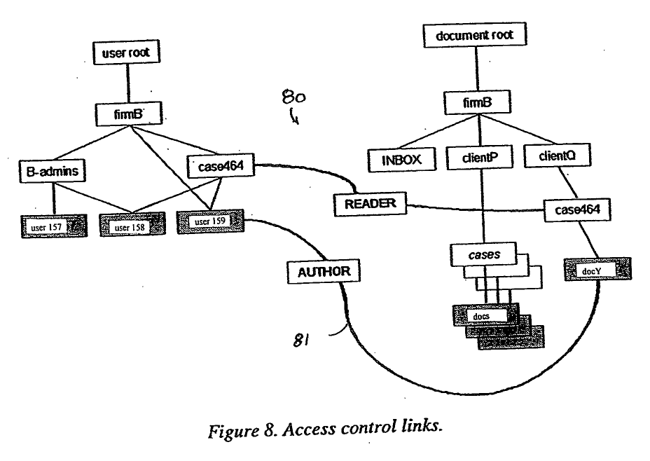

Referring now also to FIG. 8, Access Control Links (“ACLs”) grant a particular level of privilege to a particular user for a particular object. An ACL connects a subject (which may be a user or a group) to an object in the document database (which for example may be a document, category, user or group). An ACL specifies a level of privilege that a subject has on that object. For example, and still referring to FIG. 8, in the ACL exemplary embodiment schematic 80 shown therein, ACL 81 connects or associates user user159 to the category designated docY and specifies an AUTHOR privilege. User user159 can then perform on that category docY any operations for which AUTHOR privileges suffice.

If the subject of an ACL is a group rather than an individual user, then the specified privilege is preferably tacitly granted, via inheritance, to all members of that group (that is, all users who are members of the subject group, plus all users who are members of groups that are members of the subject group, and so on).

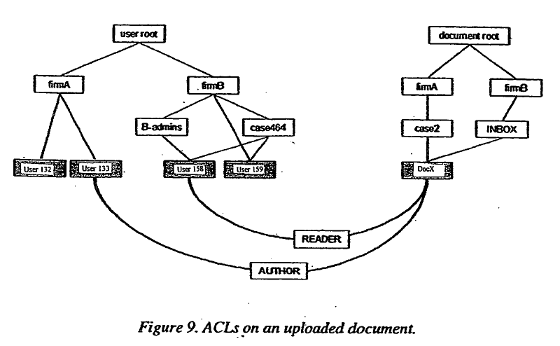

Referring now also to FIG. 9, just as groups can be used to grant several users the same privilege on a given object, categories can be used to grant a given subject the same privilege on several documents. If the object of an ACL is a category rather than an individual document, and if inheritance of the specified privilege is enabled between that category and its contents, then that privilege is preferably granted to the subject on contents of the category. Thus, groups, categories, and ACLs enable firms to conveniently authorize several users to have the same privileges on several documents. For example, the set of users working on a given case can constitute a group, and the set of documents pertaining to that case can constitute a category. A single ACL can establish privilege for those users on those documents. New documents can be added to the category, and new users added to the group, without requiring explicit access control administration.

Thus, ACLs enable appropriate protection of an uploaded document even though paths to the document may exist from several firms. Thus, ACLs coupled with groups, categories, and privileges provide a rich and flexible framework for authorization services that rule on access to documents. Other authorization mechanisms may be needed to express and enforce other types of rules, such as a restriction that a particular client can transmit documents only to a particular attorney. Such rules can be defined in user profiles and checked by the document database engine, but they should be kept relatively simple to minimize possible adverse impact on performance and usability.

Transmission, storage, retrieval, and search operations on documents are typically initiated by users from either e-mail client applications or web browsers. These applications communicate with the e-mail and web servers in the TTP system to securely transport requests from users, responses from the system, and associated document files. Web communications are preferably via HTTP, using SSL authentication and data protection, for example. E-mail communications are via protocols such as S/MIME and PGP according to an embodiment of the present invention.

The transport specific code or operations in the TTP system are preferably relegated as much as possible to the e-mail and web servers, so that the document database engine code or operations remain largely transport independent and is affected minimally by the introduction of new transport protocols or protocol versions. Thus, according to an embodiment of the present invention, the e-mail and web servers are preferably responsible for: mutually authenticating the user and the Document Server; establishing protected data communications, selecting or negotiating protocols and algorithms to provide sufficient assurance of data integrity and data confidentiality; mapping authenticated X.509 user identities to the simple user names understood by the Document Server; conveying requests, responses, and documents between the user applications and the document database engine; and capturing data signed by users that is of value for non-repudiation (e.g., signatures or envelopes in signed receipts or signed submissions) and conveying this information to the document database engine.

According to an embodiment of the present invention, the web based interface to the TTP system offers greater interactivity to users than the e-mail based interface does. Functions such as browsing, searching, tracking, and retrieving are available to users via the web interface in this embodiment. Further, the web based interface allows users to browse through the document hierarchy. A user is able to view HTML representations of categories and documents and to navigate through the hierarchy by clicking on links to the parents or children of the currently displayed object.

According to an embodiment of the present invention, the representation of a category displays a directory of links to its contents. The representation of a document displays the ancillary data associated with the document and presents buttons, for example, for operating on the document.

The web based interface preferably offers Document Server functions through two types of user interaction: simple buttons and buttons that bring up forms. A user can click a simple button while viewing a document. For example, the tracking function can be made available as a button in document views, which returns an HTML page that summarizes the document history in human-readable format. A user can use buttons to bring up forms for example, which the user then completes and submits. For example, the search function uses forms to prompt the user for keywords and other criteria, and returns an HTML page that presents links to the objects satisfying the criteria. The send function uses forms and menus to prompt the sender for the names of recipients and for ancillary document data such as an abstract, a billing label, and storage or archival options.

The web-based interface preferably straightforwardly supports virtually all of the user functionality in the TTP system, with one fundamental exception: according to one embodiment of the present invention the web interface or transport, unlike e-mail, does not deliver a document onto the computer system of a user without the active participation of that user. Therefore, when the recipient of a document transmission is a user who prefers to receive documents via the web, the TTP system can notify the user by e-mail, so that the user knows to download the document via the web.

According to an embodiment of the present invention, in effect, the transmission of a document between two web users can be decomposed into three steps: uploading, notification and downloading. Regarding uploading a document, it is performed via the web by the sender, for example. When processing an upload, the document database engine preferably creates a record in the document event queue for the ensuing notification step, and the execution of that step is driven by the document daemon. An upload places the document in a category specified by the sender. Regarding notification to the receiver, it is issued by the TTP system via the e-mail transport by which that user prefers to receive notifications, for example. The notification preferably includes a URL that the recipient can use to navigate directly to the document. Regarding downloading the document, it is performed via the web by the receiver. To enable download, the Document Server preferably creates a navigational path to the document through the inbox of the receiving firm.

An SSL handshake, which occurs when an SSL session is established, is preferably used to authenticate web users and provide data protection. As part of the handshake, the web browser and the web server negotiate a cipher suite and establish a session key for the transfer of data. The server then sends its certificate to the browser and request the user certificate from the browser. Upon receiving the user certificate, the web server calls the TTP validation service to validate it. Because the web based interface establishes a session of ongoing interaction between user and server, risks of unauthorized access, particularly while a desktop is unattended, should be considered. Security can be enhanced by requiring re-authentication after a maximum session length or a maximum inactivity period has expired. Cookies can be used to facilitate session management or to maintain state for other purposes, for example.

A strong proof of non-repudiation may include a digital signature applied by the user; for an operation involving a document, such as receipt, the document itself should be among the data signed by the user. Newer browsers are now providing form-signing capabilities, intended for use in web commerce, but these features may not enable the signing of files and may require downloads of Java or JavaScript code.
Browsers used with the TTP system preferably support SSL v3 and X.509 v3 certificates. To perform uploads and downloads of documents, browsers preferably support the <input type=file> element of HTML. This syntax is supported by Netscape Navigator 3.0, Microsoft Internet Explorer 3.02 (with patches), and later versions of those browsers, for example.

The e-mail based interface to the TTP system preferably offers only select functions of sending and receiving documents, not the more interactive functions such as browsing and searching according to one embodiment of the present invention. E-mail also is the transport by which the system sends notifications to users. The e-mail transport preferably supports protocols such as S/MIME and PGP for secure document transmission, but may use insecure e-mail in certain instances, such as for notifications for example.

When sending a document via e-mail, users preferably list recipients and provide ancillary document data in the body of the message, include the document as an attachment, and mail the message to the TTP Document Server. The list of recipients and other information in the body is in a format that the e-mail server can parse. A template in this format is preferably provided to e-mail users, and fields can be provided with default values. A message that does not specify any recipients is preferably submitted to the document database and not forwarded. A message without an attachment is preferably returned to the sender with an error message.

Unlike transmissions to web users, a document transmission to an e-mail user preferably does not involve a separate notification step. A transmission between two e-mail users preferably occurs as follows. The sender mails the one or more documents to be submitted to the TTP Document Server. The e-mail server parses the user inputs and passes control to the document database engine, which uploads the one or more documents into the database and creates a record in the document event queue for the ensuing delivery. The document daemon invokes the e-mail transport for delivery to the recipient.

Because it relies on remote mail-transfer agents for deliveries to recipients, and because these agents may return errors several hours or days after posting, the mail transport preferably includes more elaborate error handling than the web transport. For example, each outbound e-mail message, whether for notifications or for deliveries, is preferably marked by the Document Server, in the subject line for example, with unique identifying data. The data identifies the document, the forwarding event being executed, and optionally a retry serial number for that event. If any outbound mail is returned as undeliverable, the Document Server can use this information to associate the returned error with the original event, optionally initiate a retry, notify the sender of the error, and report a correct status in subsequent tracking requests. Retry algorithms preferably specify a progressive backoff of a retry frequency and a maximum number of retry attempts before delivery is abandoned and a final error status is returned.

The e-mail transport preferably uses S/MIME or PGP protocols to authenticate sending or receiving users and to assure data protection. S/MIME preferably uses X.509 certificates to represent user identities, so validation will be straightforward. PGP preferably uses PGP public keys, so the PGP e-mail agent will rely on public keys and trust values in the PGP key ring to determine validity.

Because e-mails are preferably transmitted to or from the TTP Document Server, rather than directly from user to user, PGP users share public keys only with the Document Server and preferably not with each other. Hence, as will be readily understood, the TTP system does not act as a PGP key server to PGP users.

For operations conducted via the e-mail transport to have strong non-repudiation, digitally signed receipts should be provided. S/MIME, v3 introduces support for signed receipts.

The Document Server preferably includes an infrastructure of supporting services that are used by various components of the server. These services are implemented as dynamic libraries according to an embodiment of the present invention.

A cryptographic library implements functions such as encryption, hashing, and signing according to an embodiment of the present invention. Several components of the Document Server invoke these functions, including the transport agents, the signing service, and the validation service. The cryptographic library also preferably integrates with the mechanism used to store and protect the private key of the Document Server. For example, a hardware token can both store the private key and implement some of the cryptographic functions that use the key. The set of algorithms implemented in the cryptographic services depend partly on the particular transport protocols that are supported. Algorithms can include, for example, DES, Triple DES, RC2, and IDEA for encryption; MD5 and SHA-1 for hashing; and RSA and DSA for signing.

A validation library can be used to perform the checks needed to validate X-509 v3 certificates. Validation services are invoked by various components of the TTP system: by the web server and the e-mail agents, when authenticating a party who is accessing the system; by the document database manager, when signed data recorded in a document history requires verification; and by integrity assurance tools, when verifying signed logs. Inputs to validation functions include certificates, public keys, and various signed data. Signature verification functions verify that a signed quantity has indeed been signed by using a private key corresponding to a given public key. Certificate validation functions also check for the expiration or revocation of a given certificate and of any other certificates in the chain of trust up to the SYSOP root. The validation library obtains current information on certificates and CRLs via an LDAP interface to the certificate server in the CMS. It should be recognized that the validation library may not be the sole means of certificate validation in the Document Server. The Document Server can further incorporate off-the-shelf servers and toolkits for the e-mail and web transports, and these may include their own validation code. However, this code may perform unacceptably weak validation (for example, checking for expiration but not for revocation, or checking only the first certificate in a chain). Therefore, the validation library can be used as a supplement or replacement for off-the-shelf code.

A trusted time stamping service is preferably used to generate the timestamps that are recorded in document histories and possibly also in logs. Timestamps are important elements of non-repudiation proofs, establishing the time at which a document operation occurs relative to other operations, relative to validity periods or revocations of certificates, or versus external deadlines. Time sources for the TTP system can be either internal (devices contained within the secure operating facilities for the TTP system, contacted via media also within those facilities) or external (devices outside the system, contacted via a network, a phone line, or a broadcast medium such as radio). Selection of a time source is a trade off of cost, accuracy, ease of deployment and maintenance, and vulnerability to attacks and outages. Several designs for the TTP time service may be used; the service described here employs an internal time source as the primary reference for the system and an external sources as a secondary reference. An internal time source can be conventionally based on a quartz, rubidium, or cesium oscillator, for example. According to an aspect of the present invention, a rubidium clock, barring malfunction, may be stable enough never to need adjustment, and hence the low cost of operation may justify the initial outlay. Whatever the underlying technology, an internal time source is likely to be more resistant to attacks, and in that regard more suitable as a primary reference, than an external source.

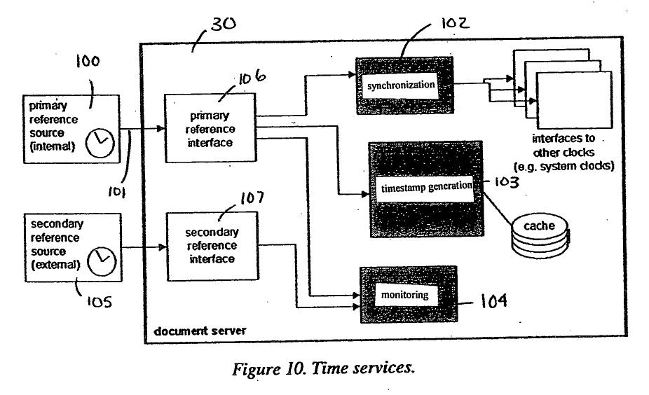

Referring now also to FIG. 10, the primary reference clock 100 is preferably connected by serial line 101 to a primary reference interface 106 of the Document Server 30 host (see FIG. 4 also). Alternatively, an external time source may deliver time values to its consumers through various media, including for example: the Internet via protocols such as the Network Time Protocol (“NTP”); dialup, to sources such as the Automated Computer Time Service (“ACTS”) of the National Institute of Standards and Technology (“NIST”); radio broadcast, from sources such as station WWV, operated by NIST, or the satellites of the Global Positioning System (“GPS”), operated by the Department of Defense. Each of these media is prone to some form of spoofing or jamming attack and/or some form of accidental outage. However, an external time source can still complement the primary reference clock in two important ways: enabling the initialization of the primary reference clock to a recognized authoritative standard; and, serving as an independent source against which the primary reference clock can be monitored. These purposes could be served well either by a GPS receiver or by one or more NTP connections to trusted hosts.

Two software modules preferably cooperate in the generation of timestamps, for the Document Server. A device-specific clock module preferably manages the interface to the primary reference clock and converts the time codes that the clock emits into a generic timestamp format. On request from other components in the Document Server, a device-independent timestamp module preferably obtains and returns a timestamp. The timestamp module maintains a cache, and optionally also a log, of timestamps that it generates. It preferably compares each timestamp that it generates against its own previous outputs, assuring that the timestamps advance monotonically. The granularity of timestamps should be fine enough to enable both monotonicity and accuracy.

Additional software modules preferably manage interfaces to secondary references and to other clocks that warrant synchronization. A secondary reference 105 communicably coupled to a secondary interface 107 of the document server 30 can optionally be polled periodically, and the time obtained from primary 100 and secondary 105 sources compared using monitoring element 104. Discrepancies are preferably logged and monitored; and a persistent and/or severe discrepancy treated as an alert condition. (Whether the primary reference will ever be adjusted to a secondary reference, under what conditions, and through what procedures, are partly questions of policy.) The time service can also use time values from the primary reference clock 100 to synchronize other clocks, such as the operating system clocks on the Document Server and CMS hosts. Although accuracy and monotonicity are not as crucial for these clocks as for the timestamping service, it is still beneficial to synchronize them, even coarsely. Many platform, transport, and network services will continue to depend on system clocks; synchronization, as is illustrated by designation 102 with the timestamp service 103 will facilitate coordination of these services and correlation of their logs.

The components of the TTP system preferably leverage a common status reporting mechanism, where practical. An extensible set of numerical status codes is preferably defined to communicate errors and other conditions between components of the system. The system emits textual status messages to log files and to user interfaces. An on-disk catalog can be used to map the status codes to these messages at runtime.

Components throughout the TTP system preferably generate logs to record the activity or status of the system. This logging facilitates the delivery or maintenance of TTP services in several ways. Diagnostic log output assists in the detection and solution of problems in system operation and performance. Logging accesses to the system, changes in certificate or user data, and changes in access control data enable monitoring and auditing of activities with potential security impacts. Logging document operations provides input data for billing and supplements document event histories as non-repudiation data. Components that generate logs preferably include the CMS, the Document Server, the web and e-mail transport agents, the time service, and the platform operating system and network services. A UNIX “syslog” mechanism is preferably used to manage concurrent access to a log file by several services, and many existing UNIX and networking services can already log to it. Automated procedures can be used to manage the archival of logs and ensure their integrity. Logs in the TTP system, including logs from the CMS, the Document Server, and the transport agents, are preferably retained on disk for a limited time, then archived to permanent media. Logs are preferably retrievable from the archival media at any future time, should they be needed for non-repudiation purposes.

While on disk, each log file can optionally be periodically retired and replaced with a fresh, e.g. empty, log file to which new entries are then directed. The retired log file can be labeled, by appending to the file name a suffix that denotes the time of retirement for example. For instance, if log files were replaced on a daily basis, a retired log file might be given a suffix in the form “1999.123.1”. This procedure of retiring and labeling log files prepares each file for permanent archival. A log file can optionally be deleted from disk after any archival procedures and post-processing procedures (such as for billing) on the file have completed.

To ensure their integrity, Document Server logs are preferably periodically signed, facilitating the detection of any subsequent tampering. Signing can occur whenever a log is retired and labeled, but signing could also occur more frequently to further restrict opportunities for tampering. The signature of one log file can be included in the first log entry in the next file as well.

Depending on the duties and the hours of coverage that are defined for the operational staff of the TTP system, it may be desirable for the system to provide alert services, which expedite response to serious error conditions. Circumstances that trigger alerts may include by way of example: fatal errors reported from a component of the system; suspected intrusions or other security problems; excessive skew between the primary reference clock and the backup clocks; performance degradation; and depletion of disk, memory, or other resources for example.

An alert can result in notification of operation staff via e-mail, telephone, beeper, or another messaging medium. Some conditions may result in automated responses, such as shutting down the system or disabling Internet access. Alerts can also preferably be raised by explicit calls from TTP component code and/or by tools that monitor log output.

The TTP system provides a partially automated mechanism to perform two services that copy data to off-line media: backups of all data in the TTP system to rotated media; and archival of all document history data, most logs, and selected documents to permanently retained media. Backup and archival operations preferably occur regularly during relatively quiescent periods. The document daemon and/or an operating system service, such as the UNIX cron daemon, preferably schedule these operations. Backups preferably take two forms: full backups, which copy large sets of data to media in their entirety; and incremental backups, which copy only objects that have changed since the previous backup. Archival involves a preparatory selection phase during which the database engine queries the database to identify documents and document histories that require archival. This query preferably makes use of the fields in ancillary document data where user requests for archival, and their fulfillment, are recorded. The archival of logs is preferably coordinated with the regular retirement of log files.

Backup or archival of a document preferably includes the integrity check that is stored with the document on-line in the document database. The integrity check can be verified if the document is restored from media. The backup and archival services preferably also encrypt data that is copied to a media. For the archival service performance may be less critical than security, and due to the potential longevity of archived data, archival may be provided with relatively stronger encryption than other storage services, for example. Keys specific to this purpose are preferably controlled by SYSOP and protected, by hardware tokens for example, against misuse by intruders or by operators.

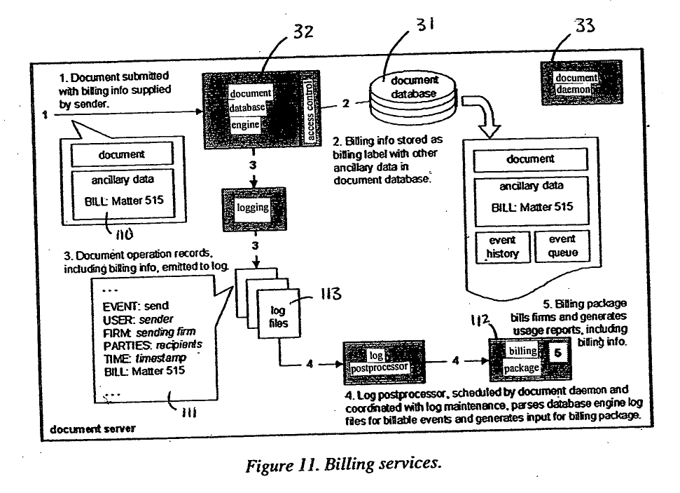

Referring now also to FIG. 11, and as described earlier, the document database 31 preferably stores billing information 110 for users and documents. A user profile may specify a billable party for services requested by the user; or default to a default value such as the firm that enrolled the user. A billing label (e.g., an account number or a matter number) is preferably stored with each document. This label may be supplied by a user or may be derived from the user profile, for example. The information in a billing label preferably passes through the document database 31 substantially unmodified and is included in Document Server log entries 111 for billable document operations. According to one embodiment of the present invention, a billing program periodically reads Document Server logs 113, processes log entries for billable operations, and generates input for a commercial billing package 112. (The processing of server log files 113 for billing may be coordinated with the periodic rolling and archival of the logs.) The billing package 112 bills the firm (or other specified billable party) for the services provided to its users by a SYSOP. It also preferably generates billing reports itemized by user and by billing label for each firm, which the firm can then use to bill its own clients.

Direct billing of a user by SYSOP (e.g., for personal use of TTP services) may involve a special case of this process, the only case in which the billing package will interpret billing labels rather than pass them through to firms. The billing package preferably recognizes the label format that requests direct billing, and bills the specified personal credit card number rather than the firm. According to an aspect of the present invention, a checksum can be calculated to confirm that the data received by the bill package or application matches that generated by the system.

For sake of completeness, the following discussion illustrates interactions among users, operators, and components of the TTP system by walking through two fundamental operations of the system, enrollment of a user and transmission of a document.

In the first scenario, a licensed professional who is an individual practitioner subscribes with a SYSOP to receive TTP services, obtaining the public key certificates and the TTP user account needed to use the system. The professional belongs to an association for which SYSOP operates a branded CA, and the association serves as an authenticating entity for its members. The professional generates a public/private key pair in a web browser and sends a certificate request to a registration agent for the branded CA. The certificate request includes the public key and the X.509 distinguished name for the professional, which was assigned by the professional association. The DN identifies the association in an organization or organizational unit attribute and identifies the individual in a common name attribute.

The branded CA processes the certificate request, creating and signing a certificate for the professional. The certificate is forwarded to the professional and also is stored within the CMS in the CA database and the certificate server database.

The professional submits forms, via the web or another medium, to the SYSOP to obtain a TTP subscription and a user account. Through a subscription form, the professional provides information needed to establish his/her individual practice as a subscribing entity for TTP services. This information includes: the names of users who will have administrative responsibility for the firm; names and addresses for billing; and default values for services such as storage and archival. Through an enrollment form, the professional provides information needed to establish himself/herself as a user of TTP services. This information includes: the DN; an e-mail address; transport preferences for document delivery; and transport preferences for notifications.

The SYSOP assigns a unique firm name to the new subscriber. The professional, in the capacity of an administrative user for the firm, assigns an individual name to himself/herself. Using information in the subscription and enrollment forms, SYSOP TTP operators create several objects in the document database: a home category in the document hierarchy for the firm; an inbox within that category; a group in the user hierarchy for the firm; an administrative subgroup within that group; and a user profile for the professional. The operators create access control links that give the professional ADMINISTRATOR privilege for these categories and groups. SYSOP staff also use information in the subscription form to input data on the firm to the TTP billing package.

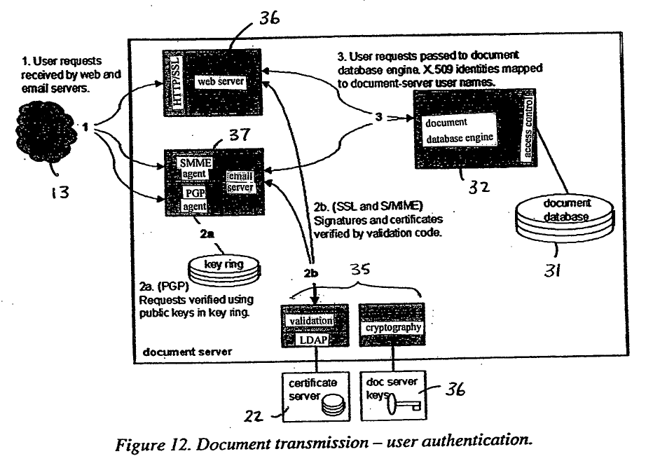

Referring now also to FIG. 12, in the second scenario a user sends a document to two recipients. The sender and one recipient prefer to use web browsers to handle documents; the other recipient prefers to use e-mail. The sender connects to the TTP Document Server in an SSL enabled web browser by opening the URL for the home category of his/her firm. The TTP web server receives a certificate from the sender via the SSL handshake, and it authenticates, the sender by validating the certificate. The web server includes the X.509 DN of the sender in all requests that it passes to the document database engine 32, and the engine 32 uses the DN to retrieve the user profile of the sender using the database 3 1.

The sender navigates through the document hierarchy to a category that the sender has targeted to contain the document. For each category that the sender traverses, the document database engine dynamically generates an HTML view that includes only the parents and children to which the sender has access. The sender navigates by clicking on links in these views. In the view for the target category, the sender clicks a SEND button, which brings up a form that prompts for recipients, text of an abstract, keywords, storage options, a billing label, and a file name for the document. The sender specifies the recipients by selecting them from a menu of firms and submenus of users. The sender types in an abstract, some keywords, and the account number for the client to which the sending firm will charge any handling costs for the document.

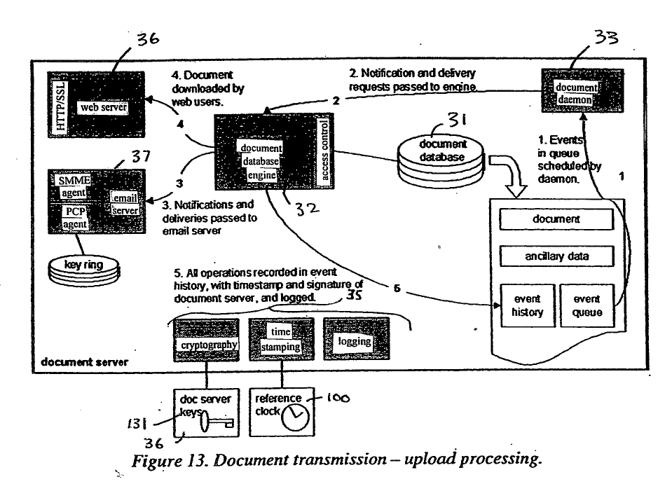

Referring now also to FIG. 13, a sender specifies the document file either by typing a path name or by browsing the local file system. The browser transmits the SEND request, with the associated information and document, to the Document Server. The database engine 32 uploads the document by creating a new document object as a child of the target category. The document object includes the document itself, the ancillary information on storage, billing, and so forth; an event queue; and an event history. The database engine 32 creates several links to establish correct access to the document: an ACL specifying that the sender has AUTHOR privilege on the document; navigational links that make the document a child of the inbox categories for the receiving firms; and access control links specifying that the recipients have READER privilege on the document. The database engine 32 creates a SEND event history record that includes the event type, the recipients, the protocols by which the document was received, a timestamp and signature. The signature is generated by using a private key 131, of the keys 36, of the document server to sign fields in the event history record plus the document itself. The database engine 32 generates an HTML page acknowledging the submission and returns this page through the web server 36 to the sender. As the last step in its direct processing of the SEND request, the database engine 32 creates three event queue records for asynchronous processing and informs the document daemon 33 of these events: an ACKNOWLEDGE event record for the sender, a NOTIFY event record for the web recipient and a DELIVER event record for the e-mail recipient.

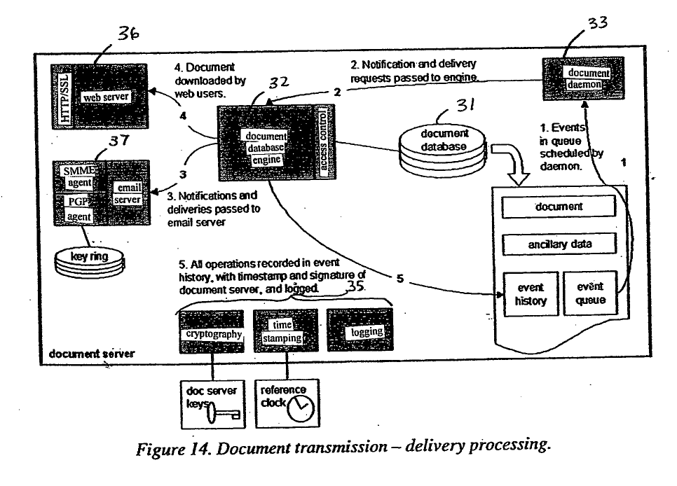

Referring now also to FIG. 14, the document daemon 33 initiates processing for each of the events in the queue, all of which involve e-mail delivery. The daemon 33 invokes the database engine 32 to compose the e-mail, look up the addresses and preferences of the recipients, and post the message through the appropriate e-mail agent. Each e-mail posting, if it is successfully processed by the TTP e-mail server 37, results in deletion of the corresponding record from the event queue and addition of a record to the event history.

The acknowledgement to the sender is a more formal version of the web acknowledgement and includes a signed receipt from the Document Server.

The notification to the web recipient indicates a URL by which the document can be downloaded. If the web recipient does download the document, this access is logged by the Document Server and added to the event history. The delivery to the e-mail recipient conveys the document as an attachment and, if the transport preferred by the recipient supports it, requests a signed receipt. If the recipient does return a signed receipt, this receipt is added to the event history.

The TTP system preferably employs a combination of measures to deter or detect threats of unauthorized access to data, compromise to the integrity of the data, or denial of services to users. Hosts in the TTP system will be protected by a firewall that allows only the access via the web and e-mail protocols that is required for the delivery of TTP services. Hosts that function as registration agents will ordinarily reside within the TTP facility, behind the firewall. However, these hosts may also operate from time to time in a standalone mode, uploading registration data at subscriber sites. Some elements of the system will be further protected by not being connected to a network at all. The CA host is preferably off-network and connected via a communications line to the on-network certificate directory host.

Critical private keys in the TTP system are preferably appropriately protected from disclosure or unauthorized use. The private key of the SYSOP root CA itself is the most critical key in the system. It is the basis for all chains of trust in the public key infrastructure and hence is fundamental to authentication in the TTP system. Storage for the root CA private key should be in a hardware device highly resistant to tampering. The private keys of the Document Server identity are also critical, since they will be used to establish authenticated and protected communications with users and to sign logs and document event histories. The certificate for a key that signs non-repudiation data is preferably accorded a long validity period, and the keys are preferably protected for that duration. (The key size is also preferably sufficiently large that the key does not become too weak before it expires.) Storage in hardware devices for Document Server keys should be considered.

Automated mechanisms to assure the integrity of the TTP system should be considered. Methods could include: signing and verification of log files, monitoring of log files, and auditing of accesses or modifications to critical system files.

Security, reliability, and availability requirements dictate some characteristics of the platforms and environment for the TTP system. Operation in a secure facility may be necessary to ensure adherence to policies and practices. Un-interruptible Power Supplies (“UPSs”) and redundant Internet connectivity can be used to reduce disruptions of service. Redundancy of disks or other hardware also helps to prevent data loss and provide a fail-over capability in the event of hardware failure. Additional platform characteristics, such as speed and capacity, will be dictated by performance and scalability requirements.

Although the invention has been described and pictured in a preferred form with a certain degree of particularity, it is understood that the present disclosure of the preferred form has been made by way of example, and that numerous changes in the details of construction and combination and arrangement of parts may be made without departing from the spirit and scope of the invention.

What is claimed is:

1. A method for providing transactional billing for trusted third party services offered to a plurality of users via a computer network, said method comprising:
generating at least one log record indicative of at least one of said users submitting at least one electronic document for trusted third party services;
generating at least one log record indicative of forwarding said at least one electronic document to at least a second of said plurality of users;
parsing said log records to generate billing information; and,
providing said billing information to at least one processing application which processes said billing information and generates a plurality of bills dependently thereupon.

2. The method of claim 1, further comprising capturing information indicative of a billing label from said first user, wherein at least a portion of said captured information is included in at least one of said log records.

3. The method of claim 2, wherein said billing label is associated with at least said submitting.

4. The method of claim 2, wherein said billing label is indicative of a client identifier.

5. The method of claim 2, wherein said billing label is indicative of a credit card.

6. The method of claim 1, further comprising capturing information indicative of a billing label from said at least second user, wherein at least some of said captured information is included in at least one of said log records.

7. The method of claim 6, wherein said billing label is associated with at least said forwarding.

8. The method of claim 6, wherein said billing label is indicative of a client identifier.

9. The method of claim 6, wherein said billing label is indicative of a credit card.

10. The method of claim 1, wherein said parsing is performed automatically and periodically.

11. The method of claim 1, further comprising generating at least one log record indicative of notifying at least said second of said plurality of users of said submitting.

12. The method of claim 11, wherein said notifying comprises generating at least one e-mail message.

13. The method of claim 12, wherein said e-mail message includes at least one electronic address associated with said computer network and the trusted third party services.

14. The method of claim 13, wherein said electronic address is a uniform resource locator.

15. The method of claim 14, wherein said uniform resource locator is further associated with said at least one submitted document.

16. The method of claim 1, wherein said log entries are indicative of discreet times respectively associated therewith.

17. The method of claim 1, wherein said users are separated into a plurality of subsets, each of said subsets being associated with a subscribing entity.

18. The method of claim 17, wherein at least one said subscribing entity is a firm.

19. The method of claim 17, further comprising providing at least one of said plurality of bills to at least one of said subscribing entities.

20. The method of claim 19, wherein said at least one electronic document and said at least one of said plurality of bills are respectively submitted and provided via said computer network.

21. The method of claim 19, wherein said at least one of said plurality of bills is provided via said computer network.

22. The method of claim 17, wherein ones of said user's in one of said subsets are associated with one or more groups.

23. The method of claim 1, further comprising storing data indicative of default billing information for each of said users.

24. The method of claim 1, wherein said at least one electronic document is submitted via said computer network.

25. The method of claim 1, wherein said computer network comprises a global interconnection of computers and computer networks.

26. The method of claim 1, further comprising generating a log record indicative of storing said at least one submitted electronic document.

27. The method of claim 26, further comprising encrypting said submitted electronic document prior to said storing.

28. The method of claim 27, further comprising generating a log record indicative of retrieving said encrypted stored electronic document.

29. The method of claim 28, further comprising decrypting said encrypted retrieved electronic document.

30. The method of claim 1, wherein said processing application comprises a commercially available billing application.

31. The method of claim 1, wherein said billing information is provided to said processing application electronically.

32. The method of claim 31, wherein said billing information is provided to said processing application electronically via a recordable media.

33. The method of claim 31, wherein said billing information is provided to said processing application electronically via a communications link.

34. The method of claim 33, wherein said communications link comprises said computer network.

35. A computer program product embodied on a computer-readable storage medium for providing transactional billing services for trusted third party services offered to a plurality of users via a computer network, the computer program product comprising:
code for generating at least one log record indicative of at least one of said users submitting at least one electronic document for trusted third party services;
code for generating at least one log record indicative of forwarding said at least one electronic document to at least a second of said plurality of users;
code for parsing said log records to generate billing information indicative of said submitting and forwarding; and,
code for providing said billing information to at least one processing application which processes said billing information and generates a plurality of bills dependently thereupon.

36. The computer program product of claim 35, said code further comprising code for capturing information indicative of a billing label from said first user, wherein at least some of said captured information is included in at least one of said log records.

37. The computer program product of claim 36, wherein said billing label is associated with at least said submitting.

38. The computer program product of claim 36, wherein said billing label is indicative of a client identifier.

39. The computer program product of claim 36, wherein said billing label is indicative of a credit card.

40. The computer program product of claim 35, said code further comprising code for capturing information indicative of a billing label from said at least second user, wherein at least some of said captured information is included in at least one of said log records.

41. The computer program product of claim 40, wherein said billing label is associated with at least said forwarding.

42. The computer program product of claim 40, wherein said billing label is indicative of a client identifier.

43. The computer program product of claim 40, wherein said billing label is indicative of a credit card.

44. The computer program product of claim 35, wherein said parsing is performed automatically and periodically.

45. The computer program product of claim 35, said code further comprising code for generating at least one log record indicative of notifying at least said second of said plurality of users of said submitting.

46. The computer program product of claim 45, wherein said notifying comprises generating at least one e-mail message.

47. The computer program product of claim 46, wherein said e-mail message includes at least one electronic address associated with said computer network and the trusted third party services.

48. The computer program product of claim 47, wherein said electronic address is a uniform resource locator.

49. The computer program product of claim 48, wherein said uniform resource locator is further associated with said at least one submitted document.

50. The computer program product of claim 35, said code further comprising code for associating a discreet time with each of said log entries.

51. The computer program product of claim 35, wherein said users are separated into a plurality of subsets, each of said subsets being associated with a subscribing entity.

52. The computer program product of claim 51, wherein at least one said subscribing entity is a firm.

53. The computer program product of claim 51, further comprising providing at least one of said plurality of bills to at least one of said subscribing entities.

54. The computer program product of claim 53, wherein said at least one electronic document and said at least one of said plurality of bills are respectively submitted and provided via said computer network.

55. The computer program product of claim 53, wherein said at least one of said plurality of bills is provided via said computer network.

56. The computer program product of claim 35, said code further comprising code for storing data indicative of default billing information for each of said users.

57. The computer program product of claim 35, wherein said at least one electronic document is submitted via said computer network.

58. The computer program product of claim 35, wherein said computer network comprises a global interconnection of computers and computer networks.

59. The computer program product of claim 35, said code further comprising code for generating a log record indicative of storing said at least one submitted electronic document.

60. The computer program product of claim 59, said code further comprising code for encrypting said submitted electronic document prior to said storing.

61. The computer program product of claim 60, said code further comprising code for generating a log record indicative of retrieving said encrypted stored electronic document.

62. The computer program product of claim 61, said code further comprising code for decrypting said encrypted retrieved electronic document.

63. The computer program product of claim 35, wherein said billing application comprises a commercially available billing application.

64. The computer program product of claim 35, wherein said billing information is provided to said processing application electronically.

65. The computer program product of claim 64, wherein said billing information is provided to said processing application electronically via a recordable media.

66. The computer program product of claim 64, wherein said billing information is provided to said processing application electronically via a communications link.

67. The computer program product of claim 66, wherein said communications link comprises said computer network.

68. A transactional billing services system for trusted third party services offered to a plurality of users via a computer network, said system comprising:
at least one database configured for storing log record indicative of at least one of said users submitting at least one electronic document for trusted third party services, and at least one log record indicative of forwarding said at least one electronic document to at least a second of said plurality of users;
at least one database engine for parsing said log records stored in said at least one database; and,
at least one billing application for generating a plurality of bills responsively to said parsing, wherein each of said bills is indicative of at least one of said log records.

69. The system of claim 68, wherein said database is further configured for storing at least one billing label associated with each of said log records.

70. The system of claim 69, wherein at least one of said billing labels is indicative of a client identifier.

71. The system of claim 69, wherein at least one of said billing labels is indicative of a credit card account.

72. The system of claim 68, wherein said database engine parses said at least one database automatically and periodically.

73. The system of claim 68, wherein said database is further configured for storing at least one log record indicative of notifying at least said second of said plurality of users of said submitting.

74. The system of claim 73, wherein said notifying comprises generating at least one e-mail message.

75. The system of claim 74, wherein said generated at least one e-mail message includes at least one electronic address associated with said computer network and the trusted third party services.

76. The system of claim 75, wherein said electronic address comprises a uniform resource locator.

77. The system of claim 76, wherein said uniform resource locator is associated with said at least one submitted document.

78. The system of claim 68, wherein each said log record is indicative of a discreet time respectively associated therewith.

79. The system of claim 68, wherein at least one of said plurality of bills is provided to at least one of said plurality of users via said computer network.

80. The system of claim 68, wherein said at least one database is further configured for storing default billing information for each of said plurality of users.

81. The system of claim 68, wherein said at least one electronic document is submitted via said computer network.

82. The system of claim 81, wherein said computer network comprises a global interconnection of computers and computer networks.

83. The system of claim 68, wherein said at least one database is further configured for storing at least one log record indicative of storing said at least one submitted electronic document.

84. The system of claim 83, further comprising at least one encryptor communicably coupled to said at least one database and for encrypting said submitted electronic document prior to said storing.

85. The system of claim 84, wherein said at least one database is further configured for storing at least one log record indicative of retrieving said encrypted stored electronic document.

86. The system of claim 85, wherein said at least one encryptor decrypts each said encrypted retrieved electronic document.

87. The system of claim 68, wherein said billing application comprises a commercially available billing application.

88. The system of claim 68, wherein said billing information is provided to said billing application via a communications link.

89. The system of claim 88, wherein said communications link comprises at least a portion of said computer network.

90. The system of claim 68, wherein said billing information is provided to said billing application via a recordable media.

91. A transactional billing services system for trusted third party services offered to a plurality of users via a computer network, said system comprising:
means for storing data signifying log records indicative of submitting ones of said users submitting electronic documents for trusted third party services, and log records indicative of said submitted electronic documents being forwarded to receiving ones of said plurality of users;
means for parsing said stored data signifying said log records; and,
means for generating a plurality of bills responsively to said means for parsing, wherein each of said bills is respectively associated with and dependent upon at least one of said log records and at least a corresponding one of said submitting or receiving ones of said users.

92. The system of claim 91, wherein said means for storing data comprises at least one database.

93. The system of claim 92, wherein said means for parsing comprises at least one database engine.

94. The system of claim 93, wherein said means for generating comprises at least one billing application.

95. The system of claim 91, wherein said means for storing further comprises means for storing data signifying billing labels respectively associated with said log records.

96. The system of claim 95, wherein at least one of said billing labels is indicative of a client identifier.

97. The system of claim 95, wherein at least one of said billing labels is indicative of a credit card account.

98. The system of claim 91, wherein said means for parsing operates at predetermined intervals.

99. The system of claim 98, wherein said predetermined intervals correspond to billing periods for said trusted third party services.

100. The system of claim 91, wherein said means for storing further comprises means for storing data signifying log records indicative of notifying said receiving ones of said users of said submitting.

101. The system of claim 100, wherein said notifying comprises generating at least one e-mail message.

102. The system of claim 101, wherein said generated at least one e-mail message includes at least one electronic address associated with said computer network and the trusted third party services.

103. The system of claim 102, wherein said electronic address comprises a uniform resource locator.

104. The system of claim 103, wherein said uniform resource locator is associated with said at least one submitted document.

105. The system of claim 91, wherein each said log record is indicative of a discreet time respectively associated therewith.

106. The system of claim 91, wherein at least one of said plurality of bills is provided to at least one of said plurality of users via said computer network.

107. The system of claim 91, wherein said means for storing comprises means for storing data signifying default billing information for each of said plurality of users.

108. The system of claim 91, wherein said electronic documents are submitted via said computer network.

109. The system of claim 108, wherein said computer network comprises a global interconnection of computers and computer networks.

110. The system of claim 91, wherein said means for storing further comprises means for storing log records indicative of storing said submitted electronic documents.

111. The system of claim 110, further comprising means for encrypting said submitted electronic documents prior to said storing.

112. The system of claim 111, wherein said means for storing log records indicative of retrieving said encrypted stored electronic documents.

113. The system of claim 112, wherein said means for encrypting further comprises means for decrypting each said retrieved encrypted electronic document.

114. The system of claim 113, wherein said means for encrypting comprise at least one encryptor/decryptor unit communicably coupled to said means for storing.

115. The system of claim 91, wherein said means for parsing and means for generating are communicable coupled via at least a portion of said computer network.

116. The system of claim 91, further comprising at least one recordable media accessible by both said means for parsing and means for generating.
